(19) United States
(12) Patent Application Publication
(10) Pub. No.: US 2019/0114122 A1
(43) Pub. Date: Apr. 18, 2019

(54) INFORMATION PROCESSING SYSTEM, AND INFORMATION PROCESSING APPARATUS

(71) Applicant: Kazuya Tani, Kanagawa (JP)

(72) Inventor: Kazuya Tani, Kanagawa (JP)

(73) Assignee: Ricoh Company, Ltd., Tokyo (JP)

(21) Appl. No.: 16/160,088

(22) Filed: Oct. 15, 2018

(30) Foreign Application Priority Data
Oct. 18, 2017 (JP) 2017-201708
Aug. 2, 2018 (JP) 2018-145846

(51) Int. Cl. G06F 3/12; H04N 1/00

(52) U.S. Cl. CPC G06F 3/1245; H04N 1/0001; H04N 2201/0094; G06F 3/1247; G06F 3/1206

(57) ABSTRACT

An information processing system to convert a first document file, including main data and setting information for processing the main data, processable by a first information processing apparatus to a second document file, including main data and setting information for processing the main data, processable by a second information processing apparatus, includes circuitry configured to determine whether a first data structure of the setting information proces sable by the first information processing apparatus and a second data structure of the setting information proces sable by the second information processing apparatus are different, and convert the first data structure of the setting information in the first document file into the second data structure of the setting information proces sable by the second information processing apparatus to generate the second document file when determining that the first data structure and the second data structure are different.

### CROSS-REFERENCE TO RELATED APPLICATION

This application claims priority pursuant to 35 U.S.C. § 119(a) to Japanese Patent Application Nos. 2017-201708, filed on Oct. 18, 2017, and 2018-145846, filed on Aug. 2, 2018 in the Japan Patent Office, the disclosures of which are incorporated by reference herein in its entirety.

### BACKGROUND

### Technical Field

This disclosure relates to an information processing system, and an information processing apparatus.

### Background Art

Image forming apparatuses using external storage devices such as hard disk drive (HDD), which accumulate document files to be printed, are known. Some image forming apparatuses reprint a document file read from the external storage device at the local apparatuses, and also allows the document file to be transferred to another image forming apparatus so that the document file can be reused by another image forming apparatus.

For example, conventional image forming apparatuses transfer facsimile data between the image forming apparatuses. One image forming apparatus determines whether a data format applied to the facsimile data can be utilized by another image forming apparatus used as a data migration destination. If the data format applied to the facsimile data can be used at another image forming apparatus used as the data migration destination, the facsimile data is transferred to another image forming apparatus used as the data migration destination. If the data format applied to the facsimile data cannot be used at another image forming apparatus used as the data migration destination, the data format applied to the facsimile data is converted a standard data format (e.g., PostScript format), and then the facsimile data is transferred to another image forming apparatus used as the data migration destination. In this way, the facsimile data can be transferred between the image forming apparatuses even if there is a difference in the data format, and the facsimile data can be utilized in the image forming apparatus used as the data migration destination.

### SUMMARY

In one aspect of the present invention, an information processing system to convert a first document file processable by a first information processing apparatus to a second document file processable by a second information processing apparatus is devised. Each of the first document file and the second document file includes main data, and setting information retaining data described in accordance with a given data structure used for processing the main data. The information processing system includes circuitry configured to determine whether a first data structure of the setting information processable by the first information processing apparatus and a second data structure of the setting information proces sable by the second information processing apparatus are different, and convert the first data structure of the setting information in the first document file into the second data structure of the setting information processable by the second information processing apparatus to generate the second document file when determining that the first data structure and the second data structure are different.

In another aspect of the present invention, an information processing apparatus, to convert a first document file processable by the information processing apparatus into a second document file processable by another information processing apparatus, each of the first document file and the second document file including main data, and setting information retaining data described in accordance with a given data structure used for processing the main data, is devised. The information processing apparatus includes circuitry configured to perform first determination processing to determine whether a first data structure of the setting information proces sable by the information processing apparatus and a second data structure of the setting information proces sable by the another information processing apparatus are different, and convert the first data structure of the setting information in the first document file into the second data structure of the setting information processable by the another information processing apparatus to generate the second document file when determining that the first data structure and the second data structure are different by performing the first determination processing.

In another aspect of the present invention, an information processing apparatus, to receive a first document file processable by another information processing apparatus, the information processing apparatus capable of processing second document file, each of the first document file and the second document file including main data, and setting information retaining data described in accordance with a given data structure used for processing the main data, is devised. The information processing apparatus includes circuitry configured to receive the first document file from the another information processing apparatus, perform first determination processing to determine whether a first data structure of the setting information processable by the another information processing apparatus and a second data structure of the setting information processable by the information processing apparatus are different, and convert the first data structure of the setting information in the first document file into the second data structure of the setting information processable by the information processing apparatus when determining that the first data structure and the second data structure are different by performing the first determination processing.

### BRIEF DESCRIPTION OF THE DRAWINGS

A more complete appreciation of the description and many of the attendant advantages and features thereof can be readily obtained and understood from the following detailed description with reference to the accompanying drawings, wherein:

FIG. 1 an example of a schematic structure of document files;

FIGS. 2A and 2B are examples of a system configuration of an information processing system according to a first embodiment;

FIG. 3 is an example of a hardware block diagram of an image forming apparatus;

FIG. 4 is an example of a functional block diagram of the image forming apparatus of FIG. 3;

FIG. 5 is an example of a sequence diagram of a first migration processing sequence of a document file according to the first embodiment;

FIG. 6 is an example of a sequence diagram of a second migration processing sequence of a document file according to the first embodiment;

FIG. 7 is an example of a flow chart illustrating the steps of a determination process performed in step S9 of FIGS. 5 and 6;

FIG. 8 is an example of a system configuration of an information processing system according to a second embodiment;

FIG. 9 is an example of a hardware block diagram of a cloud server;

FIG. 10 is an example of a functional block diagram of the cloud server of FIG. 9;

FIG. 11 is an example of a sequence diagram of a migration process of a document file according to the second embodiment;

FIG. 12 is an example of a system configuration of an information processing system according to a third embodiment;

FIG. 13 is an example of a sequence diagram of a first migration processing sequence of a document file according to the third embodiment;

FIG. 14 is an example of a sequence diagram of a second migration processing sequence of a document file according to the third embodiment;

FIG. 15 is an example of a flow chart illustrating the steps of processing when transfer (transmission) of a document file is interrupted according to a fourth embodiment;

FIG. 16 is an example of a resume selection screen; and

FIG. 17 is an example of a flow chart illustrating the steps of resuming a transfer of a document file.

The accompanying drawings are intended to depict embodiments of the present invention and should not be interpreted to limit the scope thereof. The accompanying drawings are not to be considered as drawn to scale unless explicitly noted.

### DETAILED DESCRIPTION

A description is now given of exemplary embodiments of the present invention. It should be noted that although such terms as first, second, etc. may be used herein to describe various elements, components, regions, layers and/or units, it should be understood that such elements, components, regions, layers and/or units are not limited thereby because such terms are relative, that is, used only to distinguish one element, component, region, layer or unit from another region, layer or unit. Thus, for example, a first element, component, region, layer or unit discussed below could be termed a second element, component, region, layer or unit without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In this description, when a first document file is transferred from one image forming apparatus (first information processing apparatus) to another image forming apparatus (second information processing apparatus), the first document file can be converted into a second document file processable by another image forming apparatus. Specifically, if a first data structure of data included in the first document file processable by one image forming apparatus (first information processing apparatus) differs from a second data structure of data included in the second document file processable by another image forming apparatus (second information processing apparatus), the first data structure of the data processable by one image forming apparatus (first information processing apparatus) is converted into the second data structure processable by another image forming apparatus (second information processing apparatus) to generate the second document file. Hereinafter, a description is given of one or more embodiments with reference to the drawings. It should be noted that components, types, combinations, shapes and relative arrangements of the components described in the embodiments are not intended to limit the scope of the present invention to a specific configuration.

### Structure of Document File:

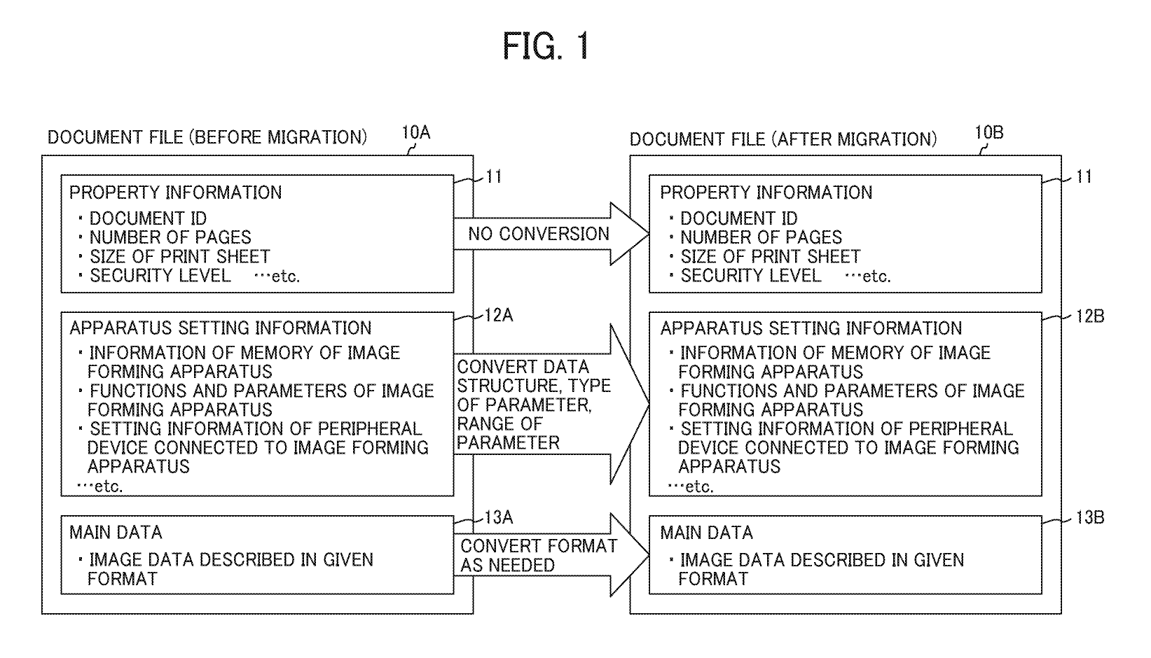

FIG. 1 an example of a schematic structure of document files. Specifically, a document file 10 (10A, 10B) includes, for example, property information 11, apparatus setting information 12 (12A, 12B), and main data 13 (13A, 13B). The property information 11 and the apparatus setting information 12 are used as metadata for the main data 13. In this description, the document file 10 may mean the document file 10A, the document file 10B, or both of the document files 10A and 10B depending on the situations. In this description, the document file 10 may mean one or more document files.

The property information 11 is property or attribute information indicating property or attribute of the main data 13. The property information 11 includes, for example, a document identification (ID) as identification information identifying the document file 10 from another document file, a data size of the document file 10, a number of pages included in the main data 13, a page size (e.g., a size of print sheet), and a security level information indicating whether access to the main data 13 is granted or not.

The apparatus setting information 12 is information related to settings of an image forming apparatus that handles or processes the document file 10. The apparatus setting information 12 includes, for example, general setting information required for handling or processing the document file 10 in the image forming apparatus, such as storing, referencing, editing, and printing. That is, the apparatus setting information 12 corresponds to information retaining data used for processing the main data 13, and the apparatus setting information 12 may vary on each image forming apparatus that handles or processes the document file. For example, when one document file is processed by a specific image forming apparatus, the one document file retains information, related to settings of the specific image forming apparatus that processes the one document file, as the apparatus setting information 12. Further, the apparatus setting information 12 can include information related to settings of one or more peripheral devices connectable to the specific image forming apparatus. In other words, the apparatus setting information 12 also corresponds to information related to an image forming environment configured by the specific image forming apparatus and one or more peripheral devices connectable to the specific image forming apparatus, which processes the document file.

By retaining information of the image forming environment in the document file, the inputting of the settings related to the printing environment when the document file is to be reprinted can be omitted. Specifically, the apparatus setting information 12 includes, for example, information related to capacity of one or more memories disposed in the image forming apparatus, functions and parameters of the image forming apparatus, and type and setting information of one or more peripheral devices connected to the image forming apparatus.

In this description, the apparatus setting information 12 is defined as a collection of data, in which a plurality of data (data elements) to be used for processing the main data 13 is described in accordance with a given data structure. The apparatus setting information 12 includes information of data structure and stored information (e.g., type of parameters, range of parameters), which become different depending on specific image forming apparatuses (or models of image forming apparatuses). The data structure defines a logical structure of the apparatus setting information 12, and the data structure is a description format of the data elements (or a storage format of the data elements) included in the apparatus setting information 12. The difference in mutual relationships between the data elements becomes a difference of the data structure. The difference in the mutual relationships between the data elements includes, for example, a difference in an arrangement order (description order) of parameters included in the apparatus setting information 12, a difference in an association structure between a key and a value of parameter in an associative arrangement, presence or absence of a link (reference) to each parameter, and a difference in expression of a link destination.

Further, the apparatus setting information 12 can include apparatus information (e.g., model name information), related to the image forming apparatus 100, for processing the document file 10, and version information identifying the data structure of the apparatus setting information 12, as need.

The main data 13 corresponds to data to be formed as an image by an image forming apparatus. The main data 13 includes, for example, image data (graphic data), document data, spreadsheet data, and combined data combining these data. The main data 13 is prepared and stored using a format (data format) processable by the image forming apparatus. For example, if the main data 13 is image data, a format, such as joint photographic experts group (JPEG), tagged image file format (TIFF) or the like, is used for the main data 13.

When a specific document file stored in one image forming apparatus (first image forming apparatus) is to be migrated or transferred to another image forming apparatus (second image forming apparatus), the specific document file may be required to processed so that another image forming apparatus can process the specific document file. Therefore, at least a part of the specific document file is converted, as needed, when the data is migrated from the first image forming apparatus to the second image forming apparatus. In an example case illustrated in FIG. 1, the document file 10A (i.e., first document file) indicates a file before migration (i.e., before conversion), and the document file 10B (i.e., second document file) indicates a file after the migration (i.e., after conversion). The document file 10A includes, for example, the property information 11, the apparatus setting information 12A, and the main data 13A, in which the apparatus setting information 12A includes or retains data described in accordance with a first data structure used for processing the main data 13A, and the main data 13A applied with a first format (first data format). Further, the document file 10B includes, for example, the property information 11, the apparatus setting information 12B, and the main data 13B, in which the apparatus setting information 12B includes or retains data described in accordance with a second data structure used for processing the main data 13B, and a main data 13B applied with a second format (second data format).

The property information 11 is commonly used among various image forming apparatuses. Since the property information 11 can be processed by image forming apparatus used as the migration destination apparatus without converting the data, the property information 11 is not subjected to the conversion process of data.

The apparatus setting information 12 is converted as needed. That is, if an error is to occur when the apparatus setting information 12A used at one image forming apparatus (migration source apparatus) is to be processed by another image forming apparatus (migration destination apparatus), the apparatus setting information 12A is converted into the apparatus setting information 12B proces sable by another image forming apparatus (migration destination apparatus).

For example, if the data structure of the apparatus setting information 12A processable by the one image forming apparatus (migration source apparatus) cannot be processed by another image forming apparatus (migration destination apparatus), the apparatus setting information 12A is converted into the apparatus setting information 12B having a data structure proces sable by another image forming apparatus (migration destination apparatus).

Further, if a specific parameter (an example of data element) required for operating another image forming apparatus (migration destination) is not included in the apparatus setting information 12A, the apparatus setting information 12A is converted into the apparatus setting information 12B by adding the specific parameter. When a parameter is newly added, for example, a default value is assigned to the new parameter.

Further, if a specific parameter included in the apparatus setting information 12A is not required for operating another image forming apparatus (migration destination apparatus), the apparatus setting information 12A is converted into the apparatus setting information 12B by deleting the specific parameter.

As above described, the apparatus setting information 12 is converted if the data structure processable by one image forming apparatus (migration source apparatus) is different from the data structure processable by another image forming apparatus (migration destination apparatus), and/or if a specific parameter used for one image forming apparatus (migration source apparatus) apparatus is invalid for another image forming apparatus (migration destination apparatus).

The main data 13 is converted as needed. That is, if the main data 13A described with a data format processable by one image forming apparatus (migration source apparatus) cannot be processed by another image forming apparatus (migration destination apparatus), the main data 13A is converted to main data 13B described with another data format processable by another image forming apparatus (migration destination apparatus). Further, if another image forming apparatus (migration destination apparatus) has a limit on a data size that another image forming apparatus can process, and the main data 13A has a greater data size that cannot be processed by another image forming apparatus (migration destination apparatus), the main data 13A is compressed to the main data 13B having a data size processable by another image forming apparatus (migration destination apparatus).

As described above, when the document file 10A is converted to the document file 10B, at least one of the apparatus setting information 12A and the main data 13A of the document file 10A is respectively converted to the apparatus setting information 12B and the main data 13B in accordance with another image forming apparatus (migration destination apparatus) as needed.

### System Configuration:

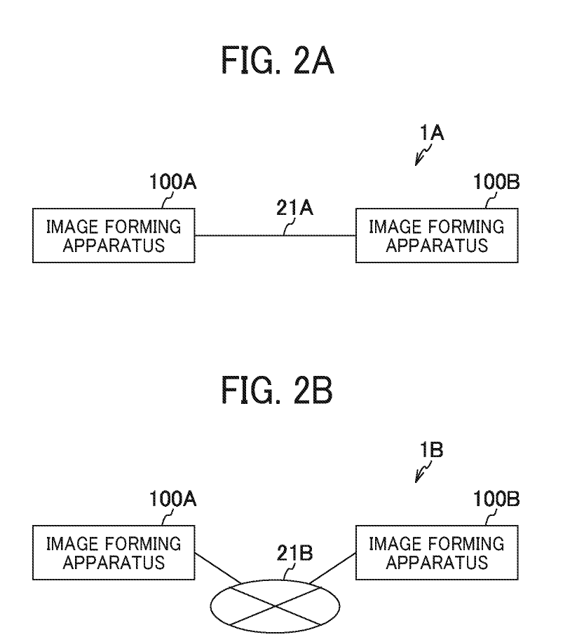

FIGS. 2A and 2B are examples of a system configuration of an information processing system according to a first embodiment. The information processing system 1 (1A, 1B) includes, for example, two image forming apparatuses 100 (100A, 100B) connected with each other via a communication path 21 (21A, 21B) to communicate data with each other.

The image forming apparatus 100 is, for example, a multifunction peripherals (MFP) equipped with a printer function for printing images on a recording medium such as a print sheet, and a scanner function for optically reading a document image and generating document image data. The image forming apparatus 100A (first information processing apparatus) is configured as an apparatus capable of processing the document file 10A including the apparatus setting information 12A defined with the first data structure, and the main data 13A defined with the first data format illustrated in FIG. 1. Further, the image forming apparatus 100B (second information processing apparatus) is configured as an apparatus capable of processing a document file 10B including the apparatus setting information 12B defined with the second data structure, and the main data 13B defined with the second format illustrated in FIG. 1.

The communication path 21 can be any one of the communication path 21A and the communication path 21B. The communication path 21A directly connects the image forming apparatuses 100A and 100B one to one to communicate data with each other as illustrated in FIG. 2A, and the communication path 21B connects the image forming apparatuses 100A and 100B via a network such as a local area network (LAN) or a wide area network (WAN) to communicate data with each other as illustrated in FIG. 2B. Further, the communication path 21 can use a wired communication such as a universal serial bus (USB) using a cable for connecting the image forming apparatuses 100A and 100B, and a wireless communication such as Bluetooth (registered trademark) or Wi-Fi (registered trademark) for connecting the image forming apparatuses 100A and 100B wirelessly.

### Hardware Configuration of Image Forming Apparatus:

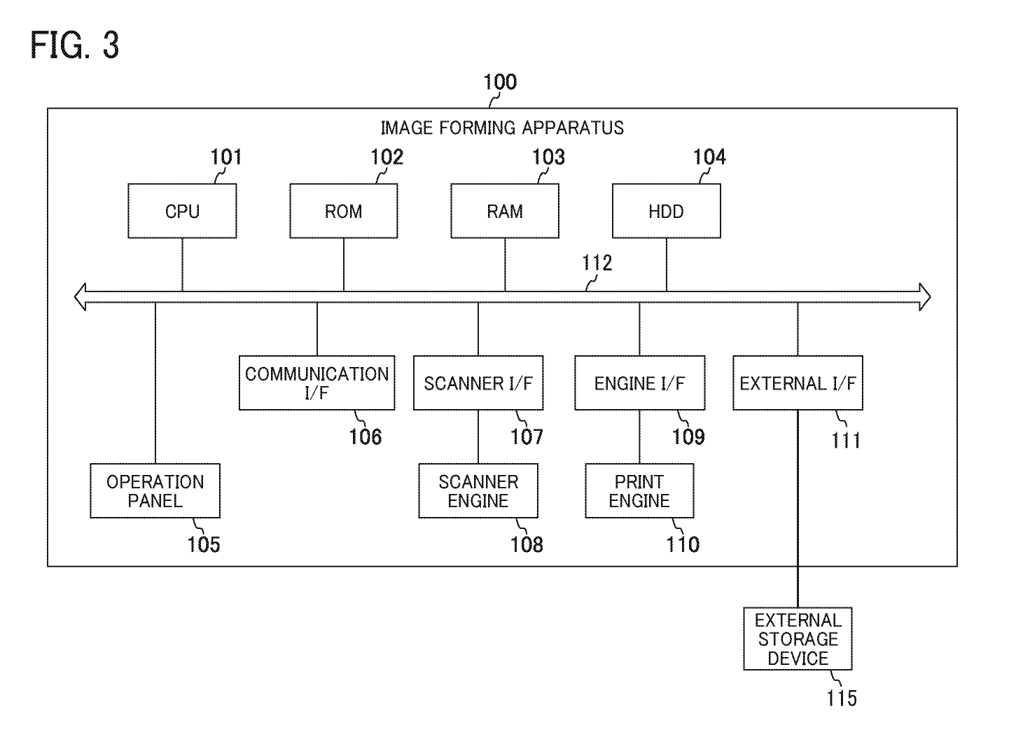

FIG. 3 is an example of a hardware block diagram of the image forming apparatus 100. The image forming apparatus 100 includes, for example, a central processing unit (CPU) 101, a read only memory (ROM) 102, a random access memory (RAM) 103, a hard disk drive (HDD) 104, an operation panel 105, a communication interface (UF) 106, a scanner interface (UF) 107, a scanner engine 108, an engine interface (UF) 109, a print engine 110, and external interface (UF) 111, connected with each other via a bus 112. The CPU 101 controls the entire image forming apparatus 100 by executing programs or the like stored in the ROM 102. The ROM 102 is a nonvolatile storage device for storing one or more control programs executable by the CPU 101 to perform a process of controlling the entire image forming apparatus 100. The RAM 103 is a volatile storage device for temporarily storing programs, data, and the like read out from the ROM 102. When the CPU 101 reads the control program from the ROM 102, loads the control program on the RAM 103, and executes the control program on the RAM 103 used as a work space, various functions are implemented.

The HDD 104 is a nonvolatile storage device for storing one or more control programs, one or more document files, and the like.

The operation panel 105 is configured to receive various inputs in accordance with an operation of a user, and to display various information such as information of the received operation, information indicating an operation status of the image forming apparatus 100, setting information, and the like. The operation panel 105 can be a liquid crystal display (LCD) or an organic electro luminescence (OEL) display device having a touch panel function mounted thereon. The operation panel 105 may include an operation device such as hardware key or a display unit such as a lamp with the display device, or include the operation device such as the hardware key or the display unit such as the lamp instead of the display device.

The communication I/F 106 is an interface for connecting directly or via a network to another image forming apparatus 100 or an information processing apparatus. The scanner I/F 107 is an interface that connects the scanner engine 108 to the bus 112. The scanner engine 108 optically reads a document image to generate image data. The engine I/F 109 is an interface for connecting the print engine 110 to the bus 112. The print engine 110 forms an image based on image data on a recording medium such as a paper, and the print engine 110 is, for example, a plotter, an inkjet printer, a laser printer, and the like. The external OF 111 is an interface for connecting an external storage device 115 to the bus 112. The external storage device 115 is a recording medium capable of being attached to and removed from the image forming apparatus 100, such as a flash memory, a hard disk drive (HDD), a solid state drive (SSD) or the like. The external storage device 115 is a nonvolatile storage for storing document files or the like. The external storage device 115 can be connected to the image processing apparatus 100 using a wired communication unit such as a USB cable or by a wireless communication unit such as Bluetooth (registered trademark) or Wi-Fi (registered trademark) so that data can be written to the external storage device 115 from the image processing apparatus 100 and can be read from the external storage device 115 by the image processing apparatus 100.

The image forming apparatus 100 operates, for example, as follows. The CPU 101 acquires image data generated by the scanner engine 108 via the scanner I/F 107, and temporarily stores the image data in the RAM 103. Further, the CPU 101 generates the document file 10 in which the property information 11 and the apparatus setting information 12 are added to the image data such as the main data 13. If the document file 10 generated by the CPU 101 is to be formed (printed) as an image, the main data 13 of the document file 10 is transmitted to the print engine 110 via the engine I/F 109, and the print engine 110 forms an image based on the main data 13 of the document file 10 on a recording medium such as a print sheet in accordance with the apparatus setting information 12. Further, if the document file 10 is to be stored, the CPU 101 stores the generated document file 10 in the HDD 104.

### Functional Configuration of Image Forming Apparatus:

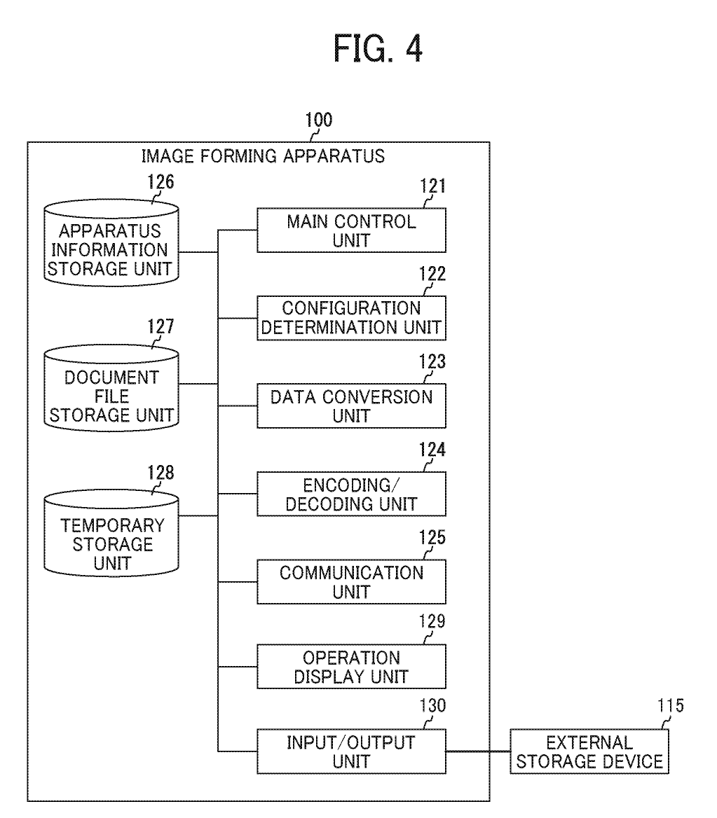

FIG. 4 is an example of a functional block diagram of the image forming apparatus 100. The image forming apparatus 100 includes, for example, a main control unit 121 (migration possibility determination unit), a configuration determination unit 122 (determination unit), a data conversion unit 123 (conversion unit), an encoding/decoding unit 124 (encryption/decryption unit), a communication unit 125, an apparatus information storage unit 126, a document file storage unit 127, and a temporary storage unit 128. The image forming apparatus 100 further includes an operation display unit 129, and an input/output unit 130.

The main control unit 121, the configuration determination unit 122, the data conversion unit 123, and the encoding/decoding unit 124 are implemented by the CPU 101 and the RAM 103 illustrated in FIG. 3. The communication unit 125 is implemented by the communication I/F 106 illustrated in FIG. 3. The apparatus information storage unit 126 and the document file storage unit 127 are implemented by the HDD 104 illustrated in FIG. 3. The temporary storage unit 128 is implemented by the RAM 103 illustrated in FIG. 3. The operation display unit 129 is implemented by the operation panel 105 illustrated in FIG. 3. The input/output unit 130 is implemented by the external I/F 111 illustrated in FIG. 3.

The main control unit 121 controls the image forming apparatus 100 entirely. The main control unit 121 also determines whether a document file can be transferred (migrated) or not.

The configuration determination unit 122 compares one apparatus information related to the apparatus configuration of the image forming apparatus 100a (migration source apparatus), and another apparatus information related to the apparatus configuration of the image forming apparatus 100B (migration destination apparatus) to determine whether one apparatus information and another apparatus information are different. Based on the difference of the apparatus information of the two image forming apparatuses 100A and 100B, the configuration determination unit 122 determines whether the data structures of the apparatus setting information 12 (FIG. 1) processable by the image forming apparatuses 100A and 100B are different or not, and determines whether the conversion of the apparatus setting information 12A included in the document file 10A (e.g., original document file) is required based on whether the first data structure of the apparatus setting information 12A processable by the image forming apparatus 100A and the second data structure of the apparatus setting information 12B processable by the image forming apparatus 100B are different. The configuration determination unit 122 determines that the conversion of the data structure of the apparatus setting information setting information 12A included in the document file 10A (e.g., original document file) is required when determining that the first data structure and the second data structure are different.

Further, the configuration determination unit 122 determines whether the conversion of the main data 13A included in the document file 10A (e.g., original document file) is required based on whether the first data format applied to the main data 13A is different from the second data format processable by the image forming apparatus 100B used as the migration destination apparatus.

If the configuration determination unit 122 determines that the data conversion of the document file 10A is required, the configuration determination unit 122 outputs information related to the conversion method of the data together with a determination result indicating whether the conversion of data is required. The information related to the conversion method of the data includes, for example, information related to changing the order of parameters in the apparatus setting information 12A, adding value, deleting value, changing value, and setting value in the apparatus setting information 12A, the data format to be applied to the main data 13A for converting the main data 13A so that the main data 13A can be processed at the migration destination apparatus, and data size of the main data that can be processed at the migration destination apparatus.

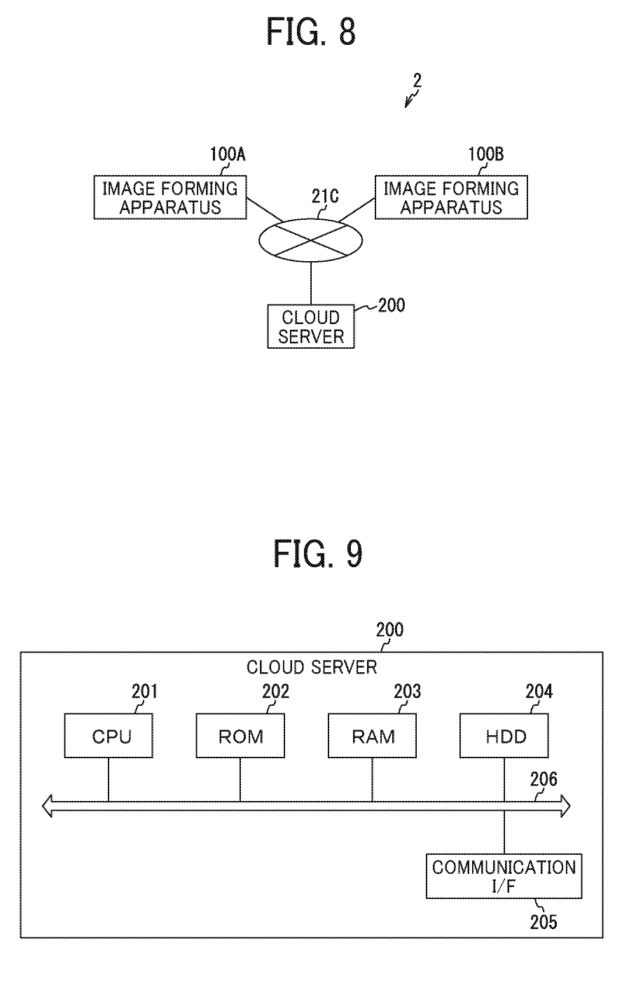

The data conversion unit 123 converts the apparatus setting information 12 and the main data 13 so that the apparatus setting information 12 and the main data 13 can be processed at the image forming apparatus 100 used as the migration destination apparatus. The data conversion unit 123 converts at least one of the apparatus setting information 12 and the main data 13 based on the determination result of the configuration determination unit 122, that is the determination result indicating whether the conversion of data is required and the information related to the conversion method of the data output from the configuration determination unit 122, to generate the converted document file. If the encoded document file is transmitted and received between one image forming apparatus 100 and another image forming apparatus 100, the encoding/decoding unit 124 encodes the document file before the transmission, and decodes the received encoded document file. The communication unit 125 transmits and receives the document file and other information between one image forming apparatus 100 and another image forming apparatus 100, and between one image forming apparatus 100 and another image forming apparatus 100 and between one image forming apparatus 100 or another image forming apparatus 100 and a cloud server 200 (see FIG. 8).

The apparatus information storage unit 126 stores apparatus information related to the apparatus configuration of the local apparatus. In this description, the local apparatus means when a specific apparatus indicates or refers to the specific apparatus itself. The apparatus information includes information for identifying a model of the local apparatus, such as the upper limit (quantity or capacity) of files that can be stored in the local apparatus, the type and version of the data format applicable to the main data 13, capacity of memory (RAM) mounted on the image forming apparatus 100 used as the local apparatus, and the like. The apparatus information can include information of a model name, and version information of the apparatus setting information 12 that can be interpreted by the local apparatus, and an endian of the image forming apparatus 100 used as the local apparatus. Whether there is a difference in the data structure of the apparatus setting information 12 that can be processed one image forming apparatus and another image forming apparatus, and content of the difference between the data structure of the apparatus setting information 12 that can be processed one image forming apparatus and another image forming apparatus can be determined based on the apparatus information stored in the apparatus information storage unit 126.

The document file storage unit 127 stores the document file 10. The temporary storage unit 128 temporarily stores data required for migrating the document file 10. The operation display unit 129 receives an input of instruction or an input of settings from a user. Further, the operation display unit 129 displays the content of the settings input via the operation display unit 129 to notify the content to the user, and displays necessary information to notify the information to the user. The input/output unit 130 connects the image forming apparatus 100 to the external storage device 115. The image forming apparatus 100 reads out document files and various information from the external storage device 115 via the input/output unit 130, and also writes the document files and various information to the external storage device 115 via the input/output unit 130.

### First Migration Processing Sequence:

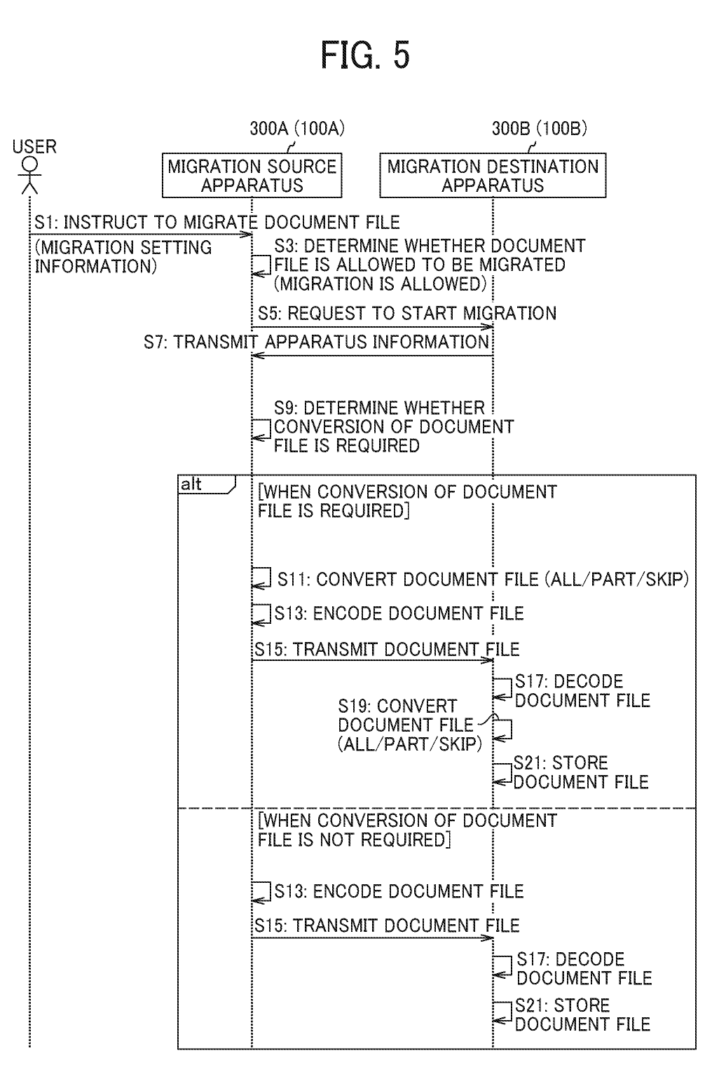

FIG. 5 is an example of a sequence diagram of a first migration processing sequence of a document file according to the first embodiment. This sequence illustrates an example case, in which the document file 10A is converted into the document file 10B at the image forming apparatus 100A (i.e., migration source of data), and then the document file 10B (converted document file) is transmitted to the image forming apparatus 100B (i.e., migration destination of data) from the image forming apparatus 100A. Hereinafter, the image forming apparatus 100A used as the migration source is also described as a “migration source apparatus 300A,” and the image forming apparatus 100B used as the migration destination is also described as a “migration destination apparatus 300B.”

In step S1, a user instructs the migration source apparatus 300A to migrate the document file 10A to the migration destination apparatus 300B. In step S1, the user uses the operation display unit 129 to set a transfer path of the document file 10A and necessity/not necessity of the encoding of the document file 10A at the time of transfer. The communication paths 21A and 21B, respectively illustrated in FIGS. 2A and 2B, can be used as the transfer path, and the user can select any of the communication paths 21A and 21B as the transfer path. The main control unit 121 of the migration source apparatus 300A retains the settings related to the transfer of the document file 10A, input by the user in the setting data, and stores the setting data in the temporary storage unit 128 (FIG. 4) of the migration source apparatus 300A. The status of each setting in the setting data is represented by, for example, a status of a flag.

In step S3, the main control unit 121 of the migration source apparatus 300A determines whether the document file 10A is allowed to be transferred to the migration destination apparatus 300B (whether the document file 10A is allowed to be migrated). Whether the document file 10A can be transferred or not is determined based on a security level set in the property information 11 (FIG. 1) of the document file 10A. If the security level is set at a level that allows data migration to another apparatus, the main controller 121 determines that the data is “transferable” and executes the sequence of step S5 and subsequent steps. On the other hand, if the security level is set at a level that does not allow the data migration to another apparatus, the main controller 121 of the migration source apparatus 300A determines that the data is “not transferable,” and displays an error message on the operation display unit 129 to inform the user that the document file 10A is not allowed to be transferred, and ends the sequence. Hereinafter, it is assumed that the main controller 121 of the migration source apparatus 300A determines that the data is “transferable.”

In step S5, the main controller 121 of the migration source apparatus 300A requests the migration destination apparatus 300B to start the migration of the document file 10A using the set transfer path.

In step S7, the main controller 121 of the migration destination apparatus 300B reads the apparatus information of the local apparatus (i.e., migration destination apparatus 300B) from the apparatus information storage unit 126 of the local apparatus (i.e., migration destination apparatus 300B), and transmits the apparatus information of the migration destination apparatus 300B to the migration source apparatus 300A. In response to receiving the apparatus information from the migration destination apparatus 300B, the migration source apparatus 300A stores the received apparatus information of the migration destination apparatus 300B in the temporary storage unit 128 of the migration source apparatus 300A.

In step S9, the configuration determination unit 122 of the migration source apparatus 300A determines whether the conversion of the document file 10A is required based on a difference between the apparatus information of the migration source apparatus 300A and the apparatus information of the migration destination apparatus 300B.

At first, the configuration determination unit 122 of the migration source apparatus 300A reads the apparatus information of the local apparatus (i.e., migration source apparatus 300A) from the apparatus information storage unit 126 of the local apparatus (i.e., migration source apparatus 300A), loads the read apparatus information on the temporary storage unit 128 of the local apparatus (i.e., migration source apparatus 300A), and compares the apparatus information of the migration source apparatus 300A and the apparatus information received from the migration destination apparatus 300B.

If the apparatus information of the migration source apparatus 300A and the apparatus information received from the migration destination apparatus 300B are the same, the configuration determination unit 122 of the migration source apparatus 300A determines that the conversion of the apparatus setting information 12A and the main data 13A included in the document file 10A are not required. On the other hand, if there is a difference between the apparatus information of the migration source apparatus 300A and the apparatus information received from the migration destination apparatus 300B, the configuration determination unit 122 of the migration source apparatus 300A determines that the conversion is required for at least the apparatus setting information 12A included in the document file 10A. That is, the configuration determination unit 122 of the migration source apparatus 300A determines that there is the difference between the data structure of the apparatus setting information processable by the migration source apparatus 300A and the data structure of the apparatus setting information proces sable by the migration destination apparatus 300B, and then determines that the conversion of the apparatus setting information 12A is required.

Further, based on the apparatus information of the migration destination apparatus 300B, the configuration determination unit 122 of the migration source apparatus 300A determines whether the migration destination apparatus 300B can process the main data 13A included in the document file 10A without converting the data format applied to the main data 13A. If the migration destination apparatus 300B cannot process the main data 13A as it is, the configuration determination unit 122 of the migration source apparatus 300A determines that the conversion of the main data 13A is required, and then determines any one of data formats that can be processed by the migration destination apparatus 300B as the data format applied to the main data to be used after the conversion. As above described, if there is the difference between the apparatus information of the two apparatuses (i.e., migration source apparatus 300A, migration destination apparatus 300B), the configuration determination unit 122 of the migration source apparatus 300A determines whether the conversion of the main data 13A is required.

If the configuration determination unit 122 of the migration source apparatus 300A determines that the conversion is required for at least any one of the apparatus setting information 12A and the main data 13A, the sequence of steps S11 to S21 is executed. On the other hand, if the configuration determination unit 122 of the migration source apparatus 300A determines that the conversion is not required for both the apparatus setting information 12A and the main data 13A, the sequence of steps S13, S15, S17, and S21 is executed.

In step S11, the data conversion unit 123 of the migration source apparatus 300A converts the document file 10A so that the migration destination apparatus 300B can process the document file 10A as the converted file. That is, the data conversion unit 123 of the migration source apparatus 300A reads the to-be-converted document file 10A from the document file storage unit 127 of the migration source apparatus 300A. Based on the determination result of the configuration determination unit 122 in step S9, the data conversion unit 123 of the migration source apparatus 300A converts the apparatus setting information 12A in the document file 10A into the apparatus setting information 12B, and further converts the main data 13A into the main data 13B as needed to generate the document file 10B.

In step S13, the encoding/decoding unit 124 of the migration source apparatus 300A encodes or encrypts the document file 10B converted from the document file 10A. If “encoding is not required” is set in step Si, step S13 is skipped.

In step S15, the main control unit 121 of the migration source apparatus 300A transmits the document file 10B to the migration destination apparatus 300B. Then, the main controller 121 of the migration destination apparatus 300B stores the received document file 10B in the temporary storage unit 128 of the migration destination apparatus 300B.

In step S17, the encoding/decoding unit 124 of the migration destination apparatus 300B decodes the received encoded document file 10B. If the encoding in step S13 is not executed, step S17 is skipped. Step S19 will be described later.

In step S21, the main control unit 121 stores the decoded document file 10B in the document file storage unit 127 of the migration destination apparatus 300B. If it is determined in step S9 that the conversion is not required for both the apparatus setting information 12A and the main data 13A, the sequence of steps S13 to S17 and S21 is executed.

### Second Migration Processing Sequence:

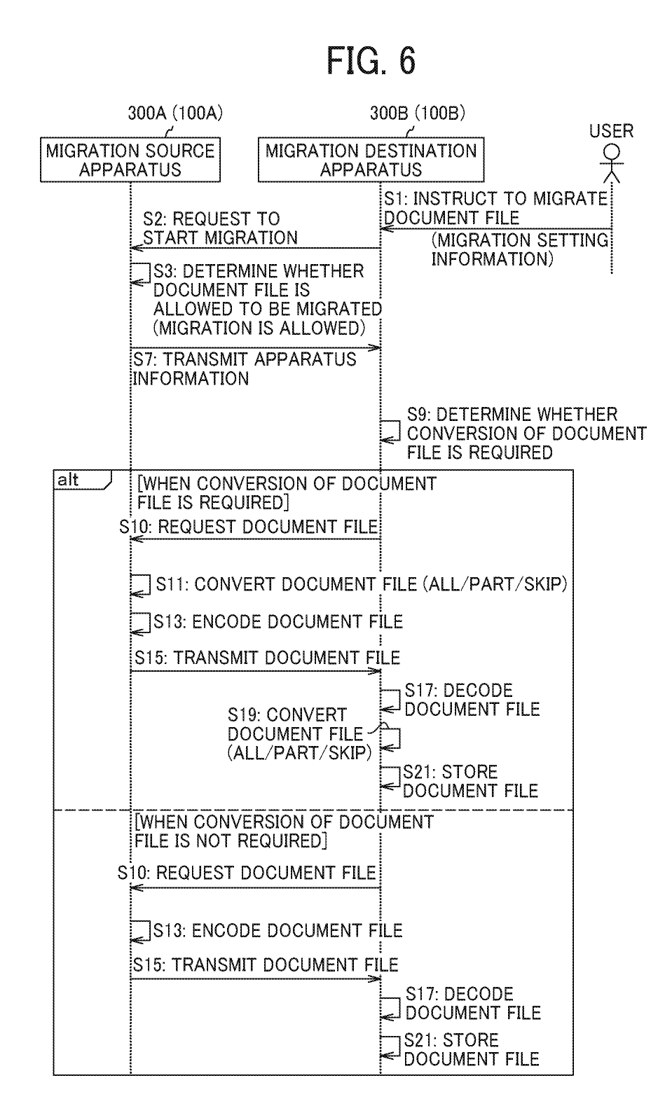

FIG. 6 is an example of a sequence diagram of a second migration processing sequence of a document file according to the first embodiment. This sequence illustrates an example case, in which the apparatus information of the document file 10A before the data conversion is transmitted from the migration source apparatus 300A (i.e., the image forming apparatus 100A used as the data migration source) to the migration destination apparatus 300B (i.e., the image forming apparatus 100B used as the data migration destination), and the migration destination apparatus 300B determines whether the document file 10A is required to be converted to generate the document file 10B. Hereinafter, the same processing as that of the first migration processing sequence is given the same step numbers, and the description thereof is omitted as appropriate.

In step S1, a user instructs the migration destination apparatus 300B to migrate the document file 10A from the migration source apparatus 300A. The main controller 121 of the migration destination apparatus 300B retains the settings related to the transfer of the document file 10A in the setting data, and stores the setting data in the temporary storage unit 128 of the migration destination apparatus 300B (FIG. 4).

In step S2, the main control unit 121 of the migration destination apparatus 300B requests the migration source apparatus 300A to start the migration of the document file 10A using the set transfer path.

In step S3, the main control unit 121 of the migration source apparatus 300A determines whether the document file 10A is allowed to be transferred to the migration destination apparatus 300B (whether the document file 10A can be migrated). If the main control unit 121 of the migration source apparatus 300A determines that the document file 10A is “transferable,” the sequence proceeds to step S7. On the other hand, if the main control unit 121 of the migration source apparatus 300A determines that the document file 10A is “not transferable,” the main control unit 121 of the migration source apparatus 300A transmits a message of “not transferable” to the migration destination apparatus 300B.

In step S7, the main control unit 121 of the migration source apparatus 300A reads the apparatus information of the local apparatus (i.e., migration source apparatus 300A) from the apparatus information storage unit 126 of the local apparatus (i.e., migration source apparatus 300A), and transmits the apparatus information of the migration source apparatus 300A to the migration destination apparatus 300B. In response to receiving the apparatus information from the migration source apparatus 300A, the main control unit 121 of the migration destination apparatus 300B stores the received apparatus information of the migration source apparatus 300A in the temporary storage unit 128 of the migration destination apparatus 300B. In step S7, the main control unit 121 of the migration source apparatus 300A transmits information related to the data format applied to the main data 13A in the document file 10A (i.e., migration target) to the migration destination apparatus 300B.

In step S9, the configuration determination unit 122 of the migration destination apparatus 300B determines whether the conversion of the document file 10A is required based on the difference between the apparatus information of the migration source apparatus 300A and the apparatus information of the migration destination apparatus 300B.

If the configuration determination unit 122 of the migration destination apparatus 300B determines that the conversion of the document file 10A is required in step S9, the sequence proceeds to step S10.

In step S10, the main control unit 121 of the migration destination apparatus 300B requests the document file 10A to the migration source apparatus 300A. In step S10, if the migration source apparatus 300A is required to execute one or more processing for the document file 10A, the main control unit 121 of the migration destination apparatus 300B also requests the migration source apparatus 300A to execute the one or more processing. The one or more processing required to be executed in relation to the document file 10A is, for example, an encoding process of the document file 10A. Step S11 will be described later.

In step S13, the encoding/decoding unit 124 of the migration source apparatus 300A encodes the document file 10A. If “encoding is not required” is set in step S1, step S13 is skipped.

In step S15, the main control unit 121 of the migration source apparatus 300A transmits the document file 10A to the migration destination apparatus 300B. Then, the main controller 121 of the migration destination apparatus 300B stores the received document file 10A in the temporary storage unit 128 of the migration destination apparatus 300B.

In step S17, the encoding/decoding unit 124 of the migration destination apparatus 300B decodes the received encoded document file 10A, and stores the decoded document file 10A in the temporary storage unit 128 of the migration destination apparatus 300B. If the encoding in step S13 is not executed, step S17 is skipped.

In step S19, the data conversion unit 123 of the migration destination apparatus 300B converts the document file 10A so that the migration destination apparatus 300B can process the document file 10A. That is, the data conversion unit 123 of the migration destination apparatus 300B reads the document file 10A from the temporary storage unit 128 of the migration destination apparatus 300B, converts the apparatus setting information 12A in the document file 10A into the apparatus setting information 12B based on the determination result of the configuration determination unit 122 in step S9, and further converts the main data 13A into the main data 13B as needed to generate the document file 10B.

In step S21, the main control unit 121 of the migration destination apparatus 300B stores the document file 10B in the document file storage unit 127 of the migration destination apparatus 300B.

If the configuration determination unit 122 of the migration destination apparatus 300B determines that the conversion of document file 10A is not required in step S9, the processing is executed as follows.

In step S10, the main control unit 121 of the migration destination apparatus 300B requests the document file 10A to the migration source apparatus 300A. In step S10, if the migration source apparatus 300A is required to execute one or more processing for the document file 10A, the main control unit 121 of the migration destination apparatus 300B also requests the migration source apparatus 300A to execute the one or more processing. The one or more processing required to be executed in relation to the document file 10A is, for example, an encoding process of the document file 10A.

In step S13, the encoding/decoding unit 124 of the migration source apparatus 300A encodes the document file 10A. If “encoding is not required” is set in step S1, step S13 is skipped.

In step S15, the main control unit 121 of the migration source apparatus 300A transmits the document file 10A to the migration destination apparatus 300B. Then, the main controller 121 of the migration destination apparatus 300B stores the received document file 10A in the temporary storage unit 128 of the migration destination apparatus 300B.

In step S17, the encoding/decoding unit 124 of the migration destination apparatus 300B decodes the received encoded document file 10A. If the encoding in step S13 is not executed, step S17 is skipped.

In step S21, the main control unit 121 of the migration destination apparatus 300B stores the decoded document file 10A in the document file storage unit 127 of the migration destination apparatus 300B.

In the above described first transfer processing sequence, the determination whether the document file 10A is allowed to be transferred is performed by the migration source apparatus 300A (step S3 in FIG. 5), while in the second transfer processing sequence, the determination whether the document file 10A is allowed to be transferred can be performed by the migration destination apparatus 300B, in which information required for determining whether the document file 10A is allowed to be transferred is transmitted from the migration source apparatus 300A to the migration destination apparatus 300B before determining whether the document file 10A is allowed to be transferred at the migration destination apparatus 300B.

### Determination Process in Step S9:

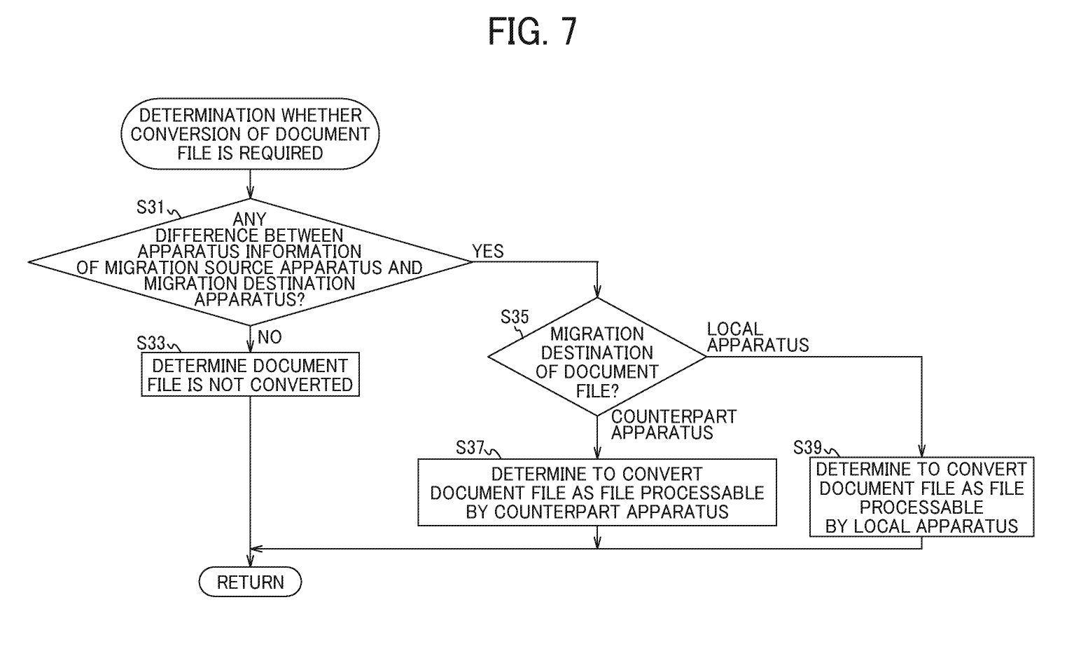

Hereinafter, a description is given of the determination process in step S9 illustrated in FIGS. 5 and 6 with reference to FIG. 7. Since the same application program can be used at the migration source apparatus 300A and the migration destination apparatus 300B, step S9 can be executed as follows. FIG. 7 is an example of a flow chart illustrating the steps of the determination process performed in step S9.

In step S31, the configuration determination unit 122 determines whether there is a difference between the apparatus information of the migration source apparatus 300A and the apparatus information of the migration destination apparatus 300B.

If there is no difference between the apparatus information of the migration source apparatus 300A and the apparatus information of the migration destination apparatus 300B (step S31: NO), in step S33, the configuration determination unit 122 determines that the document file 10A is not converted. One the other hand, if there is the difference between the apparatus information of the migration source apparatus 300A and the apparatus information of the migration destination apparatus 300B (step S31: YES), the configuration determination unit 122 performs the processing in step S35.

In step S35, the configuration determination unit 122 determines a migration destination of the document file 10A. In step S35, the configuration determination unit 122 determines whether the migration processing of the document file 10A is initiated by the migration source apparatus 300A or the migration destination apparatus 300B.

If the configuration determination unit 122 of the migration source apparatus 300A determines that the document file 10A is to be migrated to the migration destination apparatus 300B (i.e., counterpart apparatus of the migration source apparatus 300A) in step S35, the configuration determination unit 122 of the migration source apparatus 300A determines to convert the document file 10A in accordance with the document file that can be processed by the counterpart apparatus in step S37. In this case, the local apparatus (i.e., migration source apparatus 300A) executes a process of transmitting the document file 10B, converted from the document file 10A, to the migration destination apparatus 300B.

Further, if the configuration determination unit 122 of the migration target apparatus 300B determines that the document file 10A is to be migrated to the migration destination apparatus 300B itself (i.e., local apparatus) in step S35, the configuration determination unit 122 of the migration target apparatus 300B determines to convert the document file 10A in accordance with the document file that can be processed by the local apparatus (i.e., migration target apparatus 300B) in step S39. In this case, after converting the document file 10A into the document file 10B by the local apparatus (i.e., migration target apparatus 300B), the local apparatus (i.e., migration target apparatus 300B) stores the document file 10B in the document file storage unit 127 of the local apparatus (i.e., migration target apparatus 300B).

In the above described step S35, the configuration determination unit 122 of the migration source apparatus 300A or the configuration determination unit 122 of the migration destination apparatus 300B determines where the document file 10A is to be transferred to and then converted using which apparatus, in which the same application program can be used by the migration source apparatus 300A and the migration destination apparatus 300B.

### Document File Conversion Process:

Hereinafter, a description is given of the conversion process of the document file in steps S11 and S19. The conversion of the data included the document file 10A is basically executed by an apparatus that transmits a migration start request (steps S5 or S2). That is, in the first embodiment, if the migration source apparatus 300A outputs the migration start request (step S5), the migration source apparatus 300A converts all the data that are required for the conversion, and if the migration destination apparatus 300B outputs the migration start request (step S2), the migration destination apparatus 300B converts all the data that are required for the conversion. However, it is also possible that the migration source apparatus 300A converts a part of the data that is required for the conversion, and the migration destination apparatus 300B converts remainder of the data, and further, the apparatus that has received the migration start request can convert all the data that are required for the conversion. Whether the conversion of data is executed by the migration source apparatus 300A or the migration destination apparatus 300B can be determined by the configuration determination unit 122 of the concerned apparatus in step S9, which has output the migration start request, and then the data conversion unit 123 of the migration source apparatus 300A or the data conversion unit 123 of the migration destination apparatus 300B can perform the data conversion based on the determination in step S9. Hereinafter, variations of the determination result of step S9 are described.

### When Migration Source Apparatus Requests Migration Start of Document File:

Hereinafter, a description is given of a case when the migration source apparatus 300A requests the migration start of the document file 10A, and the configuration determination unit 122 of the migration source apparatus 300A performs the determination processing in step S9. If the migration source apparatus 300A is a newer model than the migration destination apparatus 300B, the configuration determination unit 122 of the migration source apparatus 300A can determine to convert the conversion-required data in the document file 10A in the migration source apparatus 300A. The configuration determination unit 122 can determine old and new models of the apparatuses based on the apparatus information.

The conversion of data is determined as follows. For example, if there is a parameter in the apparatus setting information 12A that cannot be interpreted by the migration destination apparatus 300B, the configuration determination unit 122 can determine to change a value of the parameter to a default value or to delete the parameter (key). Further, for example, if the data format applied to the main data 13A does not match the data format processable by the migration destination apparatus 300B, the configuration determination unit 122 can determine to convert the main data 13 into the main data described in a general-purpose format or another format that can be processed by the migration destination apparatus 300B. For example, if the capacity of memory (e.g., RAM) mounted in the migration destination apparatus 300B is smaller than the capacity of memory (e.g., RAM) mounted in the migration source apparatus 300A, the configuration determination unit 122 can determine to compress the main data 13A to a size that can be processed by the migration destination apparatus 300B.

If the migration source apparatus 300A is an older model than the migration destination apparatus 300B and the conversion is required for both the apparatus setting information 12 and the main data 13, the configuration determination unit 122 of the migration source apparatus 300A can determine to convert any one of the apparatus setting information 12 and the main data 13 (a part or portion of the data) in the document file 10A at the migration source apparatus 300A, and to convert the other one of the apparatus setting information 12 and the main data 13 (remaining part or portion of the data) in the document file 10A at the migration destination apparatus 300B. The method of determining the data conversion by the configuration determination unit 122 is described as above. In this case, among the settings related to the conversion of each data in the document file 10A, the settings related to the conversion of the data to be converted by the migration destination apparatus 300B is transmitted to the migration destination apparatus 300B together with the document file 10A in step S15. In step S15, the migration source apparatus 300A generates a document file (i.e., third document file) of an intermediate document file, in which a part of the data that is required for conversion is converted, and then transmits the document file (i.e., third document file) to the migration destination apparatus 300B.

Further, if the migration source apparatus 300A is an older model than the migration destination apparatus 300B, the configuration determination unit 122 of the migration source apparatus 300A can determine to convert all the data required for conversion in the document file 10A at the migration destination apparatus 300B. In this case, the settings related to the conversion of each data in the document file 10A is transmitted to the migration destination apparatus 300B together with the document file 10A in step S15.

### When Migration Destination Apparatus Requests Migration Start of Document File:

Hereinafter, a description is given of another case when the migration destination apparatus 300B requests the migration start of the document file 10A, and the configuration determination unit 122 of the migration destination apparatus 300B performs the determination processing in step S9. If the migration destination apparatus 300B is a newer model than the migration source apparatus 300A, the configuration determination unit 122 of the migration destination apparatus 300B can determine to convert all the data required for the conversion in the document file 10A at the migration destination apparatus 300B.

The conversion of data is determined as follows. For example, if there is a parameter in the apparatus setting information 12A that cannot be interpreted by the migration destination apparatus 300B (or not used in the migration destination apparatus 300B), the configuration determination unit 122 of the migration destination apparatus 300B can determine to change a value of the parameter to a default value or to delete the parameter. Further, if the migration destination apparatus 300B is compatible to a new parameter, the configuration determination unit 122 of the migration destination apparatus 300B can determine to add the new parameter with a default value. For example, if the migration destination apparatus 300B is compatible to a new data format applicable to the main data 13, the configuration determination unit 122 can determine to convert the data format of the main data 13A into the new data format.

If the migration destination apparatus 300B is an older model than the migration source apparatus 300A, and the conversion is required for both the apparatus setting information 12 and the main data 13, the configuration determination unit 122 of the migration destination apparatus 300B can determine to convert any one of the apparatus setting information 12 and the main data 13 in the document file 10A (a portion of the data) at the migration source apparatus 300A, and to convert the other one of the apparatus setting information 12 and the main data 13 in the document file 10A (remaining portion of the data) at the migration destination apparatus 300B. The method of determining the data conversion by the configuration determination unit 122 is described as above. In this case, among the settings related to the conversion of each data in the document file 10A, the settings related to the conversion of the data to be converted by the migration source apparatus 300A is transmitted to the migration source apparatus 300A together with the request of the document file 10A in step S10. Further, in step S11, the migration source apparatus 300A generates a document file (i.e., third document file) of an intermediate document file, in which a part of the data that is required for conversion is converted, and, in step S15, the migration source apparatus 300A transmits the document file (i.e., third document file) to the migration destination apparatus 300B.

If the migration destination apparatus 300B is an older model than the migration source apparatus 300A, the configuration determination unit 122 of the migration destination apparatus 300B can determine to convert all the data required for the conversion in the document file 10A at the migration source apparatus 300A. In this case, the settings related to the conversion of each data in the document file 10A is transmitted to the migration source apparatus 300A together with the request of the document file 10A in step S10.

### User Setting:

Further, a user can input the settings indicating which of the migration source apparatus 300A and the migration destination apparatus 300B is to be used to convert each data in the document file 10A from the operation display unit 129 in step S1. In this case, based on the settings input by the user, the configuration determination unit 122 causes the data conversion unit 123 to perform the conversion of each data. When the user instructs the image forming apparatus 100 (i.e., migration source apparatus 300A or migration destination apparatus 300B) to migrate the document file (step S1), all document files stored in the document file storage section 127 of the migration source apparatus 300A can be set as the migration target. However, the user can optionally select one or more document files as the document files to be migrated from the migration source apparatus 300A to the migration destination apparatus 300B in step S1, and can instruct the migration of the selected one or more document files. The image forming apparatus 100, which is instructed to migrate the document file in step S1, stores a list of one or more document files to be migrated in the temporary storage unit 128 together with the setting data. Based on the list, the image forming apparatus 100 (i.e., migration source apparatus or the migration destination) sequentially executes a migration possibility determination process, a document file conversion process, and a document file transmission process for each document file to be migrated.

In the first embodiment, based on the difference between the apparatus information of the image forming apparatus used as the migration source apparatus and the apparatus information of the image forming apparatus of used as the migration destination apparatus, the configuration determination unit determines the necessity/not necessity of conversion of the apparatus setting information and the main data of the document file. If the data structure of the apparatus setting information processable by the migration source apparatus and the data structure of the apparatus setting information processable by the migration destination apparatus are different, the data structure of the apparatus setting information is converted, the parameter is deleted as needed, and/or the parameter is added using the default value as needed, and then the converted document file is generated. Therefore, the data in the apparatus setting information is not lost before and after the conversion of document file, and the document file can be reused at the apparatus to which the document file is migrated.

In the above described first migration processing sequence (FIG. 5), since the data conversion of the document file is executed before the document file is transferred, if the data size of the converted document file becomes smaller than before the conversion, the transfer time can be shortened. In the above described second migration processing sequence (FIG. 6), since the data conversion of the document file is executed after the document file is transferred, if the migration destination apparatus has higher processing performance, the data conversion can be executed in a shorter time than converting the data at the migration source apparatus. In the first embodiment, if the image forming apparatus used as the migration source apparatus and the image forming apparatus used as the migration destination apparatus are directly connected by the communication path 21A, the transfer speed of the document file can be faster, with which the time required for the transfer can be shortened.

In the first embodiment, the image forming apparatus is exemplified as an information processing apparatus for storing and utilizing the document file, but the first embodiment can be also applied to a system for transferring a document file stored in an information processing apparatus (e.g., personal computer) other than an image forming apparatus to another information processing apparatus. Further, in the first embodiment, the data migration of the document file including the property information, the apparatus setting information and the main data is described, but the document file can include data other than the above described data. In the first embodiment, a user may determine whether to encode the to-be-migrated document file in step S1, but the main control unit 121 can be configured to determine whether to encode the document file 10A based on the security level set in the property information 11 (FIG. 1) of the document file 10A.

### Second Embodiment

FIG. 8 is an example of a system configuration of an information processing system 2 according to a second embodiment. In the second embodiment, a cloud server 200 converts a document file in response to a request from the image forming apparatus 100 (100A, 100B). The description of the configuration similar to that of the first embodiment will be omitted as appropriate. The information processing system 2 includes, for example, two image forming apparatuses 100 (100A, 100B), and the cloud server 200 connected with each other via a communication path 21C. The communication path 21C is, for example, an Internet communication network.

FIG. 9 is an example of a hardware block diagram of the cloud server 200. The cloud server 200 includes, for example, a central processing unit (CPU) 201, a read only memory (ROM) 202, a random access memory (RAM) 203, a hard disk drive (HDD) 204, and a communication OF 205, and these components are connected with each other via a bus 206. The configuration of the cloud server 200 is similar to the configuration provided by the image forming apparatus 100 illustrated in FIG. 3, and therefore, the description thereof will be omitted.

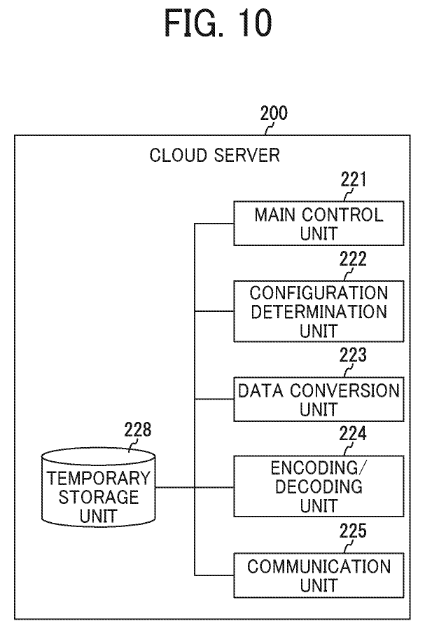

FIG. 10 is an example of a functional block diagram of the cloud server 200. The cloud server 200 includes, for example, a main control unit 221 (migration possibility determination unit), a configuration determination unit 222, a data conversion unit 223, an encoding/decoding unit 224, a communication unit 225, and a temporary storage unit 228. The functional configuration of the cloud server 200 is similar to the functional configuration of the image forming apparatus 100 illustrated in FIG. 4, and therefore the description thereof will be omitted.

### Processing Sequence:

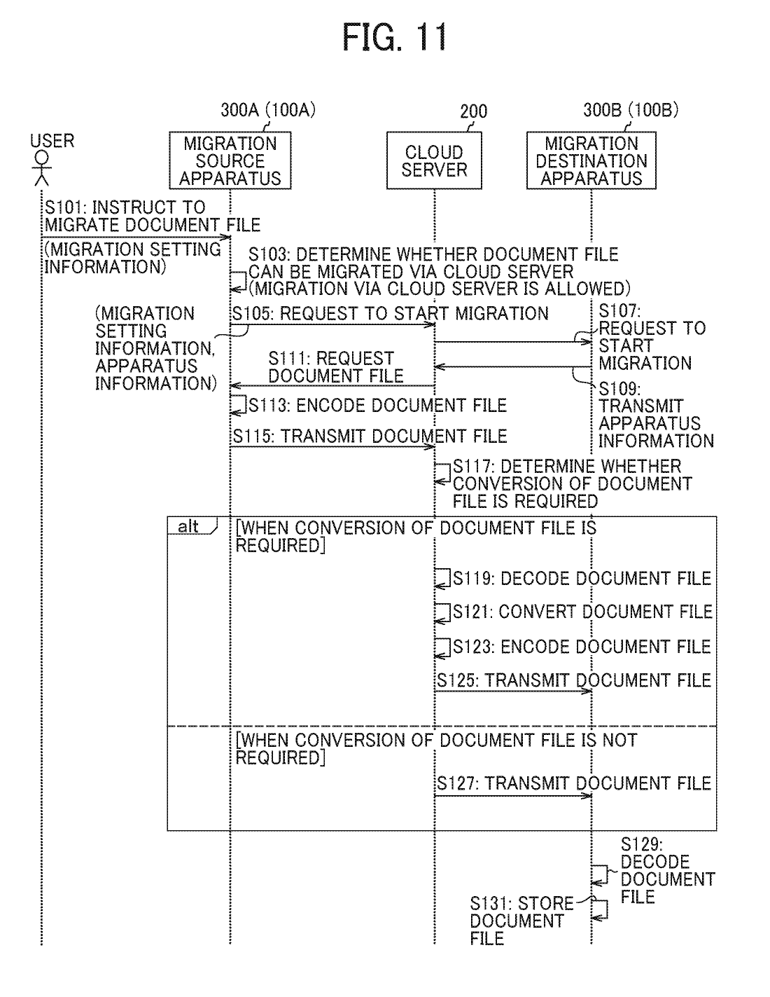

FIG. 11 is an example of a sequence diagram of a migration process of a document file according to the second embodiment. The following is an example case where a user enters a migration instruction for a document file into the migration source apparatus.

In step S101, the user instructs the migration source apparatus 300A to migrate the document file 10A to the migration destination apparatus 300B. In step S101, the user uses the operation display unit 129 to set the transfer path of the document file 10A and necessity/not necessity of the encoding of the document file 10A at the time of transfer. In this example case, it is assumed that the user selects to transfer the document file 10A through the communication path 21C, which is the Internet communication network, and to convert the document file 10A using the cloud server 200. The main control unit 121 of the migration source apparatus 300A retains the settings related to the transfer of the document file 10A in the setting data, and stores the setting data in the temporary storage unit 128 (FIG. 4) of the migration source apparatus 300A.

In step S103, the main control unit 121 of the migration source apparatus 300A determines whether the document file 10A is allowed to be transferred to the migration destination apparatus 300B (whether the document file 10A is allowed to be migrated) via the cloud server 200. The method of determining whether the document file 10A is allowed to be transferred is similar to the above described step S3. Hereinafter, it is assumed that the main control unit 121 of the migration source apparatus 300A determines that the data is “transferable.”

In step S105, the main control unit 121 of the migration source apparatus 300A requests the cloud server 200 to start the migration of the document file 10A. In addition to the migration start request, the main control unit 121 of the migration source apparatus 300A transmits the apparatus information read from the apparatus information storage unit 126 and the setting data input in step S101 to the cloud server 200. In response to receiving the apparatus information and the setting data from the migration source apparatus 300A, the cloud server 200 stores these information in the temporary storage unit 228 of the cloud server 200.

In step S107, the main control unit 221 of the cloud server 200 requests the migration destination apparatus 300B to start the migration of the document file 10A.

In step S109, the main control unit 121 of the migration destination apparatus 300B reads the apparatus information of the local apparatus (migration destination apparatus 300B) from the apparatus information storage unit 126 of the migration destination apparatus 300B, and then transmits the apparatus information of the migration destination apparatus 300B to the cloud server 200. In response to receiving the apparatus information from the migration destination apparatus 300B, the cloud server 200 stores the received apparatus information of the migration destination apparatus 300B in the temporary storage unit 228 of the cloud server 200.

In step S111, the main control unit 221 of the cloud server 200 requests the document file 10A, which a migration target, to the migration source apparatus 300A.

In step S113, the encoding/decoding unit 124 of the migration source apparatus 300A encodes the document file 10A read from the document file storage unit 127 of the migration source apparatus 300A. If “encoding is not required” is set in step S101, step S113 is skipped.

In step S115, the main control unit 121 of the migration source apparatus 300A transmits the document file 10A to the cloud server 200, and the cloud server 200 stores the received document file 10A in the temporary storage unit 228 of the cloud server 200.

In step S117, the configuration determination unit 222 of the cloud server 200 determines whether the conversion of the document file 10A is required based on the difference between the apparatus information of the migration source apparatus 300A and the apparatus information of the migration destination apparatus 300B. That is, the configuration determination unit 222 of the cloud server 200 compares the apparatus information of the migration source apparatus 300A and the apparatus information of the migration destination apparatus 300B stored in the temporary storage unit 228 of the cloud server 200. Since the determination process in step S117 is similar to the determination process in step S9, a detailed description thereof is omitted. If the configuration determination unit 222 of the cloud server 200 determines that the conversion of the document file 10A is required, the sequence of steps S119 to S125 and S129 and S131 is executed. On the other hand, if the configuration determination unit 222 of the cloud server 200 determines that the conversion of the document file 10A is not required, the sequence of steps S127, S129, and S131 is executed.

In step S119, the encoding/decoding unit 224 of the cloud server 200 decodes the received encoded document file 10A. If the encoding in step S113 is not executed, step S119 is skipped.

In step S121, the data conversion unit 223 of the cloud server 200 converts the document file 10A so that the migration destination apparatus 300B can process the document file 10A. That is, the data conversion unit 223 of the cloud server 200 reads the document file 10A from the temporary storage unit 228 of the cloud server 200, converts the apparatus setting information 12A in the document file 10A into the apparatus setting information 12B based on the determination result of the configuration determination unit 222 of the cloud server 200 in step S117, and converts the main data 13A into the main data 13B as needed, to generate the document file 10B.

In step S123, the encoding/decoding unit 224 of the cloud server 200 encodes the document file 10B after the conversion. If “no encoding” is set in step S101, step S123 is skipped.

In step S125, the main control unit 221 of the cloud server 200 transmits the document file 10B to the migration destination apparatus 300B. In response to receiving the document file 10B, the main control unit 121 of the migration target apparatus 300B stores the received document file 10B in the temporary storage unit 128 of the migration target apparatus 300B.

If it is determined that the apparatus information of the migration source apparatus 300A and the apparatus information of the migration destination apparatus 300B are the same in step S117, the sequence of steps S127, S129, and S131 is executed.

In step S127, the main control unit 221 of the cloud server 200 transmits the document file 10A, received in step S115, to the migration destination apparatus 300B. In response to receiving the document file 10A, the main control unit 121 of the migration target apparatus 300B stores the received the document file 10A in the temporary storage unit 128 of the migration target apparatus 300B.

In step S129, the encoding/decoding unit 124 of the migration destination apparatus 300B decodes the received encoded document file 10 (10A or 10B). If the encoding in step S113 or step S123 are not executed, step S129 is skipped.

In step S131, the main control unit 121 of the migration destination apparatus 300B stores the document file 10 (10A or 10B) in the document file storage unit 127 of the migration destination apparatus 300B.

Further, when the user inputs the migration instruction of the document file to the migration destination apparatus 300B, the sequence of FIG. 11 is also executed.

In the second embodiment, since the document file is transferred via the cloud server, the migration of the document file can be performed regardless of the distance between the two image forming apparatuses as long as the image forming apparatus used as the migration source apparatus and the image forming apparatus used as the migration destination apparatus are connected via a network, such as the Internet communication network. Further, since the cloud server can maintain the latest model information, the cloud server can collectively convert all of the data in the document file requiring the conversion into data in accordance with the image forming apparatus used as the migration destination apparatus. When the image forming apparatus used as the migration source apparatus and the image forming apparatus used as the migration destination apparatus are connected via any one of the communication paths 21A through 21C, the user can select the communication path and the transfer path of the document file and the apparatus (image forming apparatus or cloud server) to perform the data conversion, and can flexibly use the image forming apparatus depending on situations.

### Variant Example:

In steps S3 and S103, the main control unit 121 of the migration source apparatus 300A can determine whether the document file 10A is allowed to be transferred (whether the document file 10A is allowed to be migrated) as follows. When the user instructs the migration source apparatus 300A to migrate the document file 10A to the migration destination apparatus 300B, the migration source apparatus 300A requests the apparatus information of the migration destination apparatus 300B to the migration destination apparatus 300B. Then, the migration destination apparatus 300B transmits the apparatus information of the migration source apparatus 300A after receiving the request. Then, the main controller 121 of the migration source apparatus 300A determines whether the document file 10A can be transferred based on the apparatus information of the migration destination apparatus 300B and the document file 10A.

For example, the main control unit 121 of the migration source apparatus 300A receives the apparatus information indicating the remaining capacity of the document file storage unit 127 of the migration destination apparatus 300B, and can determine whether the document file 10A can be migrated based on the data size of the document file 10A and the remaining capacity of the document file storage unit 127 of the migration destination apparatus 300B. That is, the main control unit 121 of the migration source apparatus 300A determines that the document file 10A can be migrated when the document file storage unit 127 has the remaining capacity capable of storing the document file 10A, and the main control unit 121 of the migration source apparatus 300A determines that document file 10A cannot be migrated when the remaining capacity of document file storage unit 127 is smaller than the data size of the document file 10A.

Further, the main control unit 121 of the migration source apparatus 300A can receive the apparatus information indicating the upper limit of the number of document files that the migration destination apparatus 300B can store (e.g., the maximum number of document files storable in a document box), and can determine whether the document file 10A can be migrated based on the number of document files 10A and the upper limit of the number of document files that can be stored in the migration destination apparatus 300B. That is, the main control unit 121 determines that the document file 10A can be migrated when the number of document file 10A does not exceed the upper limit of the number of document files storable in the migration destination apparatus 300B, and the main control unit 121 determines that the document file 10A cannot be migrated when the number of document file 10A exceeds the upper limit of the number of document files storable in the migration destination apparatus 300B.

If the main control unit 121 determines that the document file 10A cannot be migrated as it is, the document file 10A corresponding to the remaining capacity of the document file storage section 127 of the migration destination apparatus 300B can be migrated, or the document file 10A corresponding to the upper limit of the number of document files, which can be stored in the migration destination apparatus 300B, can be migrated to the migration destination apparatus 300B. That is, a part of the document file 10A can be migrated based on the apparatus information of the migration destination apparatus 300B and the document file 10A. The document file 10A to be migrated can be selected in the order that is determined based on, for example, importance of the document file, the number of times the document file is accessed, the number of users sharing the document file, and the like. Further, the user can instruct whether to migrate a part of the document file 10A. In this description, the document file 10 may mean one or more document files.

Further, the migration source apparatus 300A can transfer and store the document file 10A, which is not directly migrated to the migration destination apparatus 300B, to other storage device or the cloud server by associating the not-directly migrated document file 10A with the migration destination apparatus 300B, and then the migration destination apparatus 300B can retrieve the document file 10 from other storage device or cloud server in accordance with the remaining capacity of the document file storage unit 127 of the migration destination apparatus 300B or the number of document files that can be stored in of the document file storage unit 127 of the migration destination apparatus 300B.

In addition to the remaining capacity of the document file storage unit 127 of the migration destination apparatus 300B and the upper limit of the number of the document files that can be stored in the migration destination apparatus 300B, the main control unit 121 of the migration source apparatus 300A can determine whether the document file 10A can be migrated to the migration destination apparatus 300B based on an engine resolution of the migration destination apparatus 300B (e.g., the main control unit 121 of the migration source apparatus 300A determines that the document file 10A cannot be migrated if the resolution of the document file 10A exceeds the engine resolution), or the main control unit 121 of the migration source apparatus 300A can determine whether the document file 10A can be migrated to the migration destination apparatus 300B based on an the maximum sheet size processable by the migration destination apparatus 300B (e.g., the main control unit 121 of the migration source apparatus 300A determines that one or more document files among the document file 10A cannot be migrated if the sheet size of the concerned document file exceeds the maximum sheet size processable by the migration destination apparatus 300B.

Further, the main controller 121 of the migration source apparatus 300A can determine whether the document file 10A can be transferred or allowed to be migrated based on the time required for transferring the document file 10. That is, the main controller 121 of the migration source apparatus 300A calculates the time required for transferring the document file 10A based on the data transfer rate and the data size of the document file 10A through the communication path 21 (21A, 21B, 21C) connecting the two image forming apparatuses 100A and 100B. Then, the main control unit 121 of the migration source apparatus 300A determines that the document file 10A can be migrated when the calculated transfer time is equal to or less than a given threshold, or determines that the document file 10A cannot be migrated when the calculated transfer time exceeds the given threshold.

### Third Embodiment

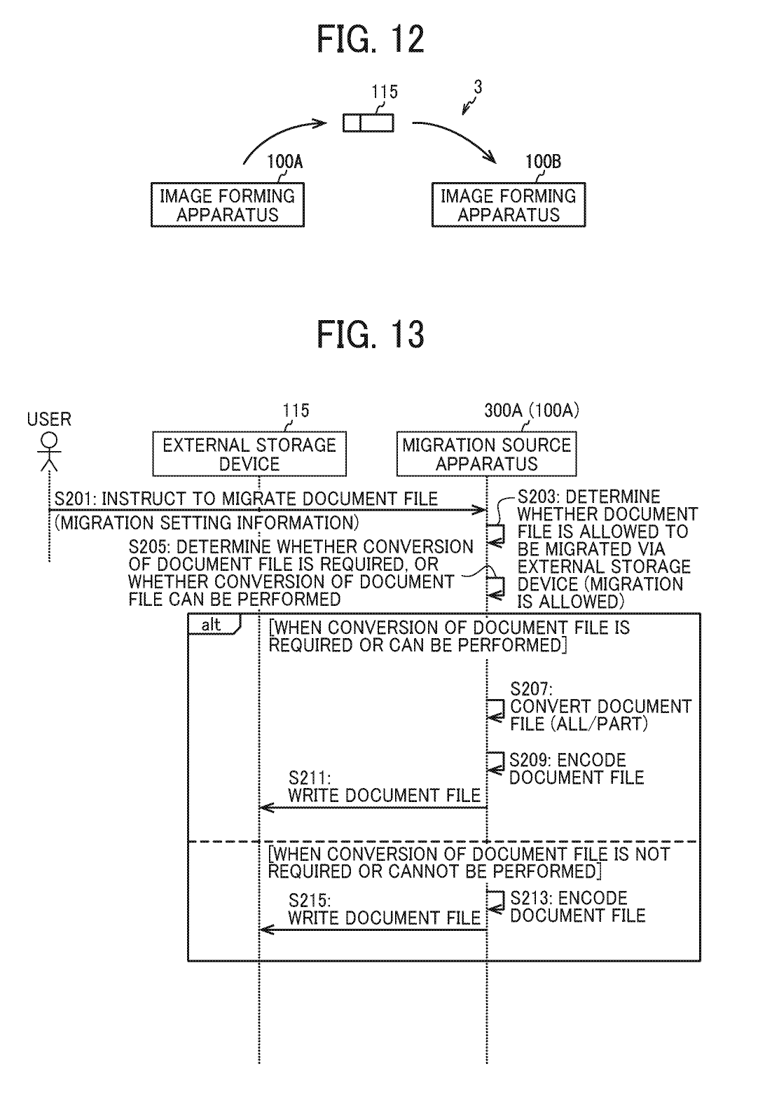

FIG. 12 is an example of a system configuration of an information processing system 3 according to a third embodiment. Hereinafter, the description of the configuration similar to that of the first and second embodiments will be omitted as appropriate. The information processing system 3 includes, for example, two image forming apparatuses 100 (100A, 100B), and an external storage device 115. In the third embodiment, the document file is transferred between the two image forming apparatuses 100 (100A, 100B) through the external storage device 115. The third embodiment can be effective when at least one of the two image forming apparatuses 100 is in a stand-alone environment and cannot communicate with each other, and when the two image forming apparatuses 100 are connected to each other as illustrated in the first embodiment (FIGS. 2A and 2B) or the second embodiment (FIG. 8) but the network environment is not good enough and the communication speed is slow or unstable.

Sequence when Migration Source Apparatus Converts Document Data:

FIG. 13 is an example of a sequence diagram of a first migration processing sequence of a document file according to the third embodiment. Hereinafter, a description is given of a sequence that the migration source apparatus 300A (image forming apparatus 100A) converts the document file 10A (FIG. 1) to the document file 10B processable by the migration destination apparatus 300B (image forming apparatus 100B), and then stores the document file 10B in the external storage device 115.

In step S201, a user instructs the migration source apparatus 300A to migrate the document file 10A. In this example case, the user instructs the migration source apparatus 300A to convert the document file 10A, and then store the converted document file in the external storage device 115. At this timing, the user uses the operation display unit 129 to set the apparatus information of the migration destination apparatus 300B and the necessity/not necessity of encoding the document file 10A. The apparatus information of the migration destination apparatus 300B input by the user is information of the model name and/or the identification (ID) of the migration destination apparatus 300B, with which the migration source apparatus 300A can identify the data structure of the apparatus setting information 12 and the data format applied to the main data 13 processable by the migration destination apparatus 300B. The main control unit 121 of the migration source apparatus 300A retains the settings related to the transfer of the document file 10A in the setting data, and stores the setting data in the temporary storage unit 128 (FIG. 4) of the migration source apparatus 300A.

In step S203, the main control unit 121 of the migration source apparatus 300A determines whether the document file 10A can be migrated to the migration destination apparatus 300B via the external storage device 115, in other words, the main control unit 121 of the migration source apparatus 300A determines whether the document file 10A can be stored in the external storage device 115. The method for determining whether the document file 10A can be stored in the external storage device 115 is similar to the above described step S3. Hereinafter, it is assumed that the document file 10A can be stored in the external storage device 115 (“storable”).

In step S205, the configuration determination unit 122 of the migration source apparatus 300A determines whether the conversion of the document file 10A is required based on the difference between the apparatus information of the migration source apparatus 300A and the apparatus information of the migration destination apparatus 300B. That is, the configuration determination unit 222 of the migration source apparatus 300A compares the apparatus information of the migration source apparatus 300A read from the apparatus information storage unit 126, and the apparatus information of the migration destination apparatus 300B stored in the temporary storage unit 228. Since the determination process in step S205 is similar to the determination process in step S9, a detailed description thereof is omitted. If the configuration determination unit 222 of the migration source apparatus 300A determines that the conversion of the document file 10A is required, the sequence of steps S207, S209, and S211 is executed. On the other hand, if the configuration determination unit 222 of the migration source apparatus 300A determines that the conversion of the document file 10A is not required, the sequence of steps S213 and S215 is executed. Further, if the apparatus information of the migration destination apparatus 300B is not input in step S201, the configuration determination unit 122 of the migration source apparatus 300A determines that the document file 10A cannot be converted, and then executes the sequence of steps S213 and S215.

In step S207, the data conversion unit 123 of the migration source apparatus 300A converts the document file 10A to a document file (e.g., document file 10B) processable by the migration destination apparatus 300B. That is, the data conversion unit 123 of the migration source apparatus 300A reads the document file 10A to be converted from the document file storage unit 127. Based on a determination result of the configuration determining unit 122 in step S205, the data conversion unit 123 of the migration source apparatus 300A converts the apparatus setting information 12A in the document file 10A into the apparatus setting information 12B, and further converts the main data 13A into the main data 13B as needed, to generate the document file 10B. Further, the data conversion unit 123 sets the apparatus information related to the apparatus corresponding to the document file 10B in the apparatus setting information 12B of the document file 10B. In this case, the apparatus information can be at least information that the migration destination apparatus 300B can determine the data structure of the apparatus setting information 12B. The apparatus information included in the apparatus setting information 12B can be the apparatus information input by the user (e.g., model name of the migration destination apparatus 300B and/or identification (ID) of the migration destination apparatus 300B) or information equivalent thereto.

In step S209, the encoding/decoding unit 124 of the migration source apparatus 300A encodes the document file 10B after the conversion in step S207. If “encoding is not required” is set in step S201, step S209 is skipped.

In step S211, the main control unit 121 of the migration source apparatus 300A writes the document file 10B to the external storage device 115 via the input/output unit 130.

Hereinafter, the sequence of steps S213 and S215 is described. In step S213, the encoding/decoding unit 124 of the migration source apparatus 300A encodes the document file 10A before the conversion. If “encoding is not required” is set in step S201, step S213 is skipped.

In step S215, the main control unit 121 of the migration source apparatus 300A writes the document file 10A to the external storage device 115 via the input/output unit 130. The apparatus setting information 12A of the document file 10A, stored in the external storage device 115, includes the apparatus information related to the apparatus corresponding to the document file 10A.

Sequence when Migration Destination Apparatus Converts Document Data:

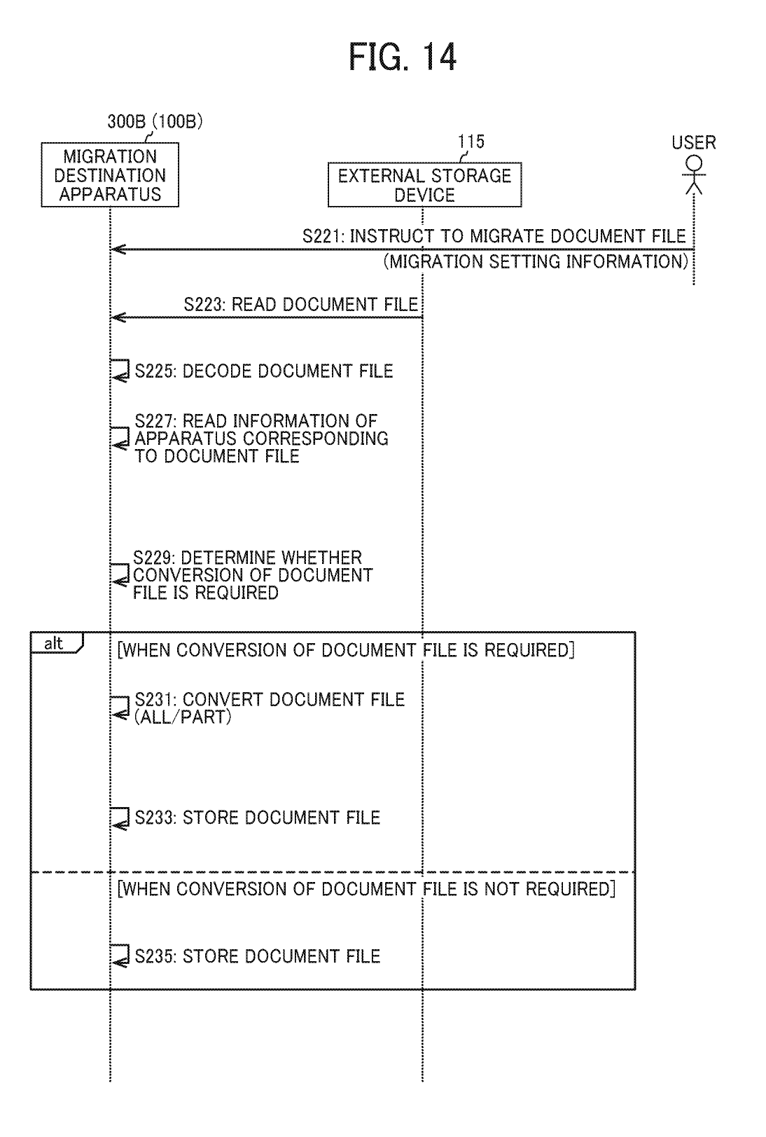

FIG. 14 is an example of a sequence diagram of a second migration processing sequence of a document file according to the third embodiment. In this example case, if all or a part of the document file stored in the external storage device 115 are not compatible to the migration destination apparatus 300B, the migration destination apparatus 300B (image forming apparatus 100B) reads the document file 10A (FIG. 1) from the external storage device 115, and converts the document file 10A so that the converted document file can be processed at the local apparatus (i.e., migration destination apparatus 300B, image forming apparatus 100B).

In step S221, a user instructs the migration destination apparatus 300B to read out the document file 10A stored in the external storage device 115.

In step S223, the main control unit 121 of the migration destination apparatus 300B reads out the designated document file 10A from the external storage device 115 via the input/output unit 130.

In step S225, the encoding/decoding unit 124 of the migration destination apparatus 300B decodes the document file 10A if the document file 10A is encoded. If the document file 10A is not encoded, step S225 is skipped.

In step S227, the configuration determination unit 122 of the migration destination apparatus 300B reads the apparatus information indicating an apparatus corresponding to the document file 10A from the apparatus setting information 12A in the document file 10A, and then stores the read apparatus information in the temporary storage unit 228 of the migration destination apparatus 300B.

In step S229, the configuration determination unit 122 of the migration destination apparatus 300B determines whether the conversion of the document file 10A is required. That is, the configuration determination unit 222 of the migration destination apparatus 300B compares the apparatus information of the migration destination apparatus 300B read from the apparatus information storage unit 126, and the apparatus information stored in the temporary storage unit 228. If the configuration determination unit 222 of the migration destination apparatus 300B determines that the conversion of the document file 10A is required, the sequence of steps S231 and S233 steps is executed. On the other hand, if the configuration determination unit 222 of the migration destination apparatus 300B determines that the conversion of the document file 10A is not required, the sequence of step S235 is executed.

In step S231, the data conversion unit 123 of the migration destination apparatus 300B converts the document file 10A to a document file processable by the migration destination apparatus 300B. That is, based on the determination result of the configuration determination unit 122 in step S229, the data conversion unit 123 of the migration destination apparatus 300B converts the apparatus setting information 12A of the document file 10A into the apparatus setting information 12B, and further converts the main data 13A to the main data 13B as needed, to generate the document file 10B.

In step S233, the main control unit 121 of the migration destination apparatus 300B writes the document file 10B to the document file storage unit 127 of the migration destination apparatus 300B.

Further, in step S235, the main control unit 121 of the migration destination apparatus 300B writes or stores the document file 10A to the document file storage unit 127 of the migration destination apparatus 300B.

As to the above described third embodiment, the document file can be transferred between two apparatuses via the external storage device 115 that can be attached to and detached from the two image forming apparatuses 100 (migration source apparatus 300A and migration destination apparatus 300B).

### Fourth Embodiment

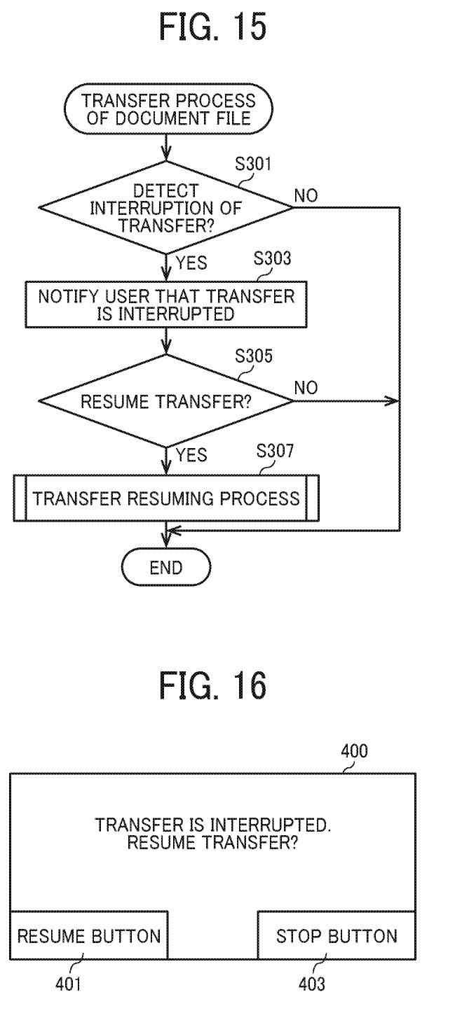

FIG. 15 is an example of a flow chart illustrating the steps of processing when the transfer (transmission) of document file is interrupted according to a fourth embodiment. Hereinafter, a description is given of processing performed by the image forming apparatus 100 when the transfer (transmission) of the document file is interrupted due to a communication error while the image forming apparatus 100 is executing the transfer (transmission) process of the document file in step S15 (FIG. 5) or another step. Hereinafter, a description is given of an example of processing performed by the image forming apparatus 100A when the user instructs the image forming apparatus 100A, used as the migration source of the document file, to migrate the document file (FIG. 5).

In step S301, the communication unit 125 of the image forming apparatus 100A monitors a transfer condition or status of the document file 10. That is, the communication unit 125 of the image forming apparatus 100A monitors the occurrence of a communication error such as a disconnection and/or a connection refusal on a network using a communication protocol such as transmission control protocol/internet protocol (TCP/IP) or the like, used for transferring the document file 10. If the communication unit 125 does not detect the interruption of the transfer during the transfer of the document file 10 (step S301: NO), the transfer (transmission) process of the document file 10 is ended. On the other hand, if the communication unit 125 detects the interruption of the transfer of the document file 10 (step S301: YES), the sequence of step S303 and subsequent steps are executed.

In step S303, the main control unit 121 notifies the user that the transfer of the document file 10 is interrupted. That is, the main control unit 121 causes the operation display unit 129 to display a resume selection screen 400 (FIG. 16) to notify that the transfer of the document file 10 is interrupted.

FIG. 16 is an example of the resume selection screen 400. The resume selection screen 400 is used to notify the user that the transfer of data of the document file 10 is interrupted, and to request the user to select whether to resume the transfer of data of the document file 10. As illustrated in FIG. 16, the resume selection screen 400 includes, for example, a resume button 401 for resuming the transfer of the data of the document file 10 from the middle of the data of the document file 10 to be transferred, and a stop button 403 for ending the transfer of the data of the document file 10 without resuming the transfer of the data of the document file 10. If the user presses the resume button 401, the “transfer resuming process” is executed, with which the transfer of data of the document file 10 is resumed after the communication environment has been restored. On the other hand, if the user presses the stop button 403, the transfer of the data of the document file 10 is stopped or terminated.

In step S305, the main control unit 121 monitors whether the instruction from the user is input via the resume selection screen 400. If the instruction to resume the transfer of the document file 10 is input by pressing the resume button 401(step S305: YES), the transfer resuming process in step S307 is executed. On the other hand, if the instruction for stopping the transfer of the document file 10 is input by pressing the stop button 403 (step S305: NO), the sequence ends.

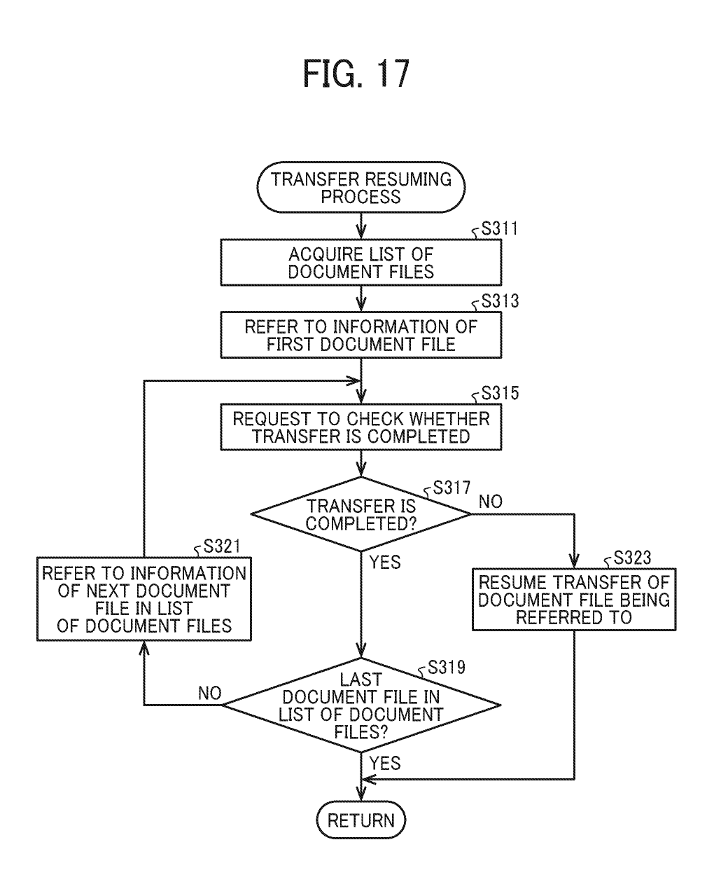

FIG. 17 is an example of a flow chart illustrating the steps of resuming the transfer of document file. The sequence of FIG. 17 indicates a subroutine of “transfer resuming process” in step S302 of FIG. 15.

In step S311, the main control unit 121 of the image forming apparatus 100A acquires a list of document file 10 that are to be migrated from the temporary storage unit 128, in which the list of the document file 10 includes one or more document files.

In step S313, the main control unit 121 of the image forming apparatus 100A selects the first document file from the list of document file 10 to be migrated, and then refers to information of the first document file. The first document file is a document file that is firstly migrated or transmitted in the migration or transmission process of a series of the document file 10.

In step S315, the main control section 121 of the image forming apparatus 100A requests the migration destination apparatus whether the entirety of the document file 10 being referenced exists in the migration destination apparatus to which the document file is to be transferred, in other words, the main control section 121 of the image forming apparatus 100A requests the migration destination apparatus to check whether the migration or transfer to the migration destination apparatus is completed for the document file being referenced. For example, the migration destination apparatus is the image forming apparatus 100B, which is a migration or transfer destination of the document file in the information processing system illustrated in FIGS. 2A and 2B. Further, for example, the migration destination apparatus is the cloud server 200 in the information processing system illustrated in FIG. 8. In response to the request from the image forming apparatus 100A, the migration destination apparatus responds “transfer completion” or “transfer incomplete” for the document file requested from the image forming apparatus 100A.

In step S317, the main control unit 121 of the image forming apparatus 100A determines whether the transfer of the document file being referenced has been completed based on the response from the migration destination apparatus. If the transfer of the document file has been completed (step S317: YES), step S319 and subsequent steps are executed, and if the transfer of the document file is incomplete (step S317: NO), step S323 is executed.

In step S319, the main control unit 121 of the image forming apparatus 100A checks whether the document file being referred to is the last document file in the list of document file 10 to be transferred. The last document file is a document file to be transferred at the very end of the document files sequentially transferred based on the list of document file 10. If the document file being referenced is the last document file (step S319: YES), the main control unit 121 ends the sequence. On the other hand, if the document file being referenced is not the last document file (step S319: NO), the main control unit 121 proceeds the sequence to step S321.

In step S321, the main control unit 121 of the image forming apparatus 100A refers to the next document file in the list of document file 10. Then, step S315 and subsequent steps are repeated.

In step S323, the main control unit 121 of the image forming apparatus 100A resumes the transfer of the document files from a specific document file being referred to, which is not yet transferred completely.

As to the fourth embodiment, when the transfer of the document file is interrupted, the user can select whether to resume or stop the transfer of the document file. Further, if the user instructs the image forming apparatus 100B (i.e. migration destination of document file) to migrate or transfer the document file to the image forming apparatus 100B in the sequence of FIG. 6, steps S301 to S305 are executed by the image forming apparatus 100B.

The above described embodiment implements the following configurations.

### First Configuration:

As to the first configuration, each of the information processing systems 1, 2, and 3 includes the first information processing apparatus (image forming apparatus 100A, migration source apparatus 300 A) capable of processing the first document file 10A, and the second information processing apparatus (image forming apparatus 100B, migration destination apparatus 300B) capable of processing the second document file 10B, in which the first document file 10A is transferred from the first information processing apparatus to the second information processing apparatus. The information processing system converts the first document file 10A processable by the first information processing apparatus into the second document file 10B processable by the second information processing apparatus. Further, each document file includes the main data 13, and the apparatus setting information 12 retaining the data described in accordance with a given data structure for processing the main data 13. In the first configuration, the determination unit (configuration determination units 122, 222) determines whether a first data structure of the setting information (e.g., apparatus setting information) processable by the first information processing apparatus and the second data structure of the setting information (e.g., apparatus setting information) processable by the second information processing apparatus are different, and the conversion unit (data conversion units 123, 223) converts the first data structure of setting information (e.g., apparatus setting information) included in the first document file into the second data structure of setting information (e.g., apparatus setting information) based on the determination result of the determination unit, to generate the second document file.

In the first configuration, the determination unit and the conversion unit can be disposed in any one of the first information processing apparatus and the second information processing apparatus, or can be disposed in another apparatus (e.g., cloud server) other than the first information processing apparatus and the second information processing apparatus. As to the first configuration, the data structure of the data in the document file is appropriately converted so that the document file can be utilized at the migration destination apparatus. That is, the determination unit determines whether there is a difference between the data structure of the setting information (e.g., apparatus setting information) that the first information processing apparatus can process and the data structure of setting information (e.g., apparatus setting information) that the second information processing apparatus can process. If the determination unit determines that the data structure of the setting information (e.g., apparatus setting information) processable by the first information processing apparatus and the data structure of the setting information (e.g., apparatus setting information) processable by the second information processing apparatus are different, the conversion unit generates the second document file by converting the data structure of the setting information (e.g., apparatus setting information) of the first document file. As described above, since the second document file is generated by appropriately converting the data structure of the setting information (e.g., apparatus setting information) in the first document file in accordance with the data structure of the setting information (e.g., apparatus setting information) of the second information processing apparatus, after the migration, the second document file can be utilized at the second information processing apparatus.

The conversion of the data structure includes, for example, a process of changing a description order of parameters in the setting information, a process of deleting a parameter (key), a process of changing a parameter (value), a process of adding a parameter using a default value, and the like. By performing such processing, the data in the setting information is not lost before and after converting the document file, and thereby the document file can be used by the apparatus to which the document file is migrated.

### Second Configuration:

As to the information processing system 1 and 2 of the second configuration, the determination unit (the configuration determination unit 122, 222) determines the difference between the first data structure and the second data structure based on the difference between the information related to the apparatus configuration of the first information processing apparatus (image forming apparatus 100A, migration source apparatus 300A) and the information related to the apparatus configuration of the second information processing apparatus (image forming apparatus 100B, migration destination apparatus 300B). In the second configuration, the determination unit determines whether the data structure of the setting information in the document file is required to converted based on the difference between the information of the apparatus configuration (apparatus information) of the first information processing apparatus and the information of the apparatus configuration (apparatus information) of the second information processing apparatus. The apparatus information may include various information which can identify a model of the information processing apparatus. If the model of the information processing apparatus can be identified, the data structure of the setting information can be identified. In the second configuration, the difference between the data structures of the data in the document files can be determined without transmitting or receiving the document file between the migration source apparatus and the migration destination apparatus.

### Third Configuration:

As to the information processing system 1 and 2 of the third configuration, the determination unit (configuration determination unit 122, 222) determines whether the first data format applied to the main data 13 included in the first document file 10A matches the second data format that can be processed by the second information processing apparatus (image forming apparatus 100B, migration destination apparatus 300B), and the conversion unit (data conversion unit 123, 223) converts the first data format applied to the first document file into the second data format that can be processed by the second information processing apparatus based on a determination result of the determination unit, to generate the second document file. In the third configuration, since the first data format applied to the main data is converted in accordance with the second data format that can be processed by the second information processing apparatus used as the migration destination apparatus as needed, the first document file can be used at the migration destination apparatus. Further, if the information related to the apparatus configuration of the first information processing apparatus and the information related to the apparatus configuration of the second information processing apparatus are the same, it can be determined that at least the conversion of the first data format applied to the main data is not required.

### Fourth Configuration:

As to the information processing system 1 and 2 of the fourth configuration, each of the document file 10 includes the attribute information (e.g., property information 11) indicating property or attribute of the main data 13, and the migration possibility determination unit (main control unit 121, 221) determines whether the first document file 10A can be migrated from the first information processing apparatus (image forming apparatus 100A, migration source apparatus 300A) to the second information processing apparatus (image forming apparatus 100B, migration destination apparatus 300B) based on the attribute information (e.g., property information 11). In the fourth configuration, the determination whether the document file 10 can be migrated is performed, for example, based on the security level set for the document file 10. If the security level of the document file 10 is higher than a given level, the document file 10 is not migrated, with which the information leakage can be reduced. Further, the determination whether the document file 10 can be migrated is performed based on the data size of the document file 10, the time required for transferring the document file 10, and the like. If the data size of the document file 10 is too great and cannot be used in the second information processing apparatus used as the migration destination apparatus, or if the data migration requires too long time, the migration of the document file 10 is stopped, with which resources of each apparatus configuring the information processing system can be effectively utilized.

### Fifth Configuration:

As to the fifth configuration, the information processing apparatus (image forming apparatus 100A, migration source apparatus 300A) migrates the first document file 10A, processable by the local information processing apparatus (image forming apparatus 100A, migration source apparatus 300A), to another information processing apparatus (image forming apparatus 100B, migration destination apparatus 300B) that can process the second document file 10B. The local information processing apparatus converts the first document file proces sable by the local information processing apparatus into the second document file processable by another information processing apparatus. In the fifth configuration, each document file includes the main data 13 and the apparatus setting information 12 retaining data described in accordance of a given data structure used for processing the main data 13. In the fifth configuration, the determination unit (configuration determination units 122) determines whether the first data structure of the setting information (e.g., apparatus setting information) processable by the local information processing apparatus and the second data structure of the setting information (e.g., apparatus setting information) processable by another information processing apparatus are different, and the conversion unit (data conversion units 123, 223) converts the data structure of setting information included in the first document file into the second data structure based on the determination result of the determination unit, to generate the second document file. Further, the local information processing apparatus can also include the communication unit (communication unit 125) for transmitting the second document file generated by the conversion unit to another information processing apparatus. In the fifth configuration, among the data in the first document file, all of data required to be converted are converted by the information processing apparatus (local apparatus) used as the migration source apparatus to generate the second document file, and then the second document file is transmitted to another information processing apparatus used as the migration destination apparatus. In the fifth configuration, since the data structure in the document file is appropriately converted, the document file can be utilized by the migration destination apparatus same as the first configuration.

### Sixth Configuration:

As to the sixth configuration, the information processing apparatus (image forming apparatus 100A, migration source apparatus 300A) migrates the first document file 10A processable by the local information processing apparatus (image forming apparatus 100A, migration source apparatus 300A) to another information processing apparatus (image forming apparatus 100B, migration destination apparatus 300B) that can process the second document file 10B. The local information processing apparatus (image forming apparatus 100A, migration source apparatus 300A) converts at least a part of the first document file processable by the local information processing apparatus in accordance with the second document file proces sable by another information processing apparatus (image forming apparatus 100B, migration destination apparatus 300B). In the sixth configuration, each document file includes the main data 13 and the apparatus setting information 12 retaining data described in accordance of a given data structure used for processing the main data 13. In the sixth configuration, the local information processing apparatus (image forming apparatus 100A, migration source apparatus 300A) includes the determination unit (configuration determination unit 122) that performs first determination processing to determine whether the first data structure of the setting information proces sable by the local information processing apparatus and the second data structure of the setting information processable by another information processing apparatus are different, and the determination unit (configuration determination unit 122) also performs second determination processing to determine whether the first data format applied to the main data included in the first document file matches the second data format processable by another information processing apparatus (image forming apparatus 100B, migration destination apparatus 300B), and the conversion unit (data conversion unit 123) performs any one of first conversion processing to convert the first data structure of the setting information included in the first document file into the second data structure based on the determination result of the first determination processing to generate the third document file, or second conversion processing to convert the first data format applied to the main data included in the first document file into the second data format based on the determination result of the second determination processing to generate the third document file. Further, the information processing apparatus may include the communication unit (communication unit 125) for transmitting the third document file to another information processing apparatus. In the sixth configuration, among the data in the first document file, a part of data (i.e., any one of the setting information and the main data) required to be converted is converted by the local apparatus used as the migration source apparatus to generate the third document file in an intermediate document file, and the third document file is then transmitted to another information processing apparatus used as the migration destination apparatus. That is, another information processing apparatus used as the migration destination apparatus converts remaining data included in the third document file required to be converted (i.e., any one of the setting information and the main data) to generate the second document file. In the sixth configuration, since the data structure in the document file is appropriately converted, the document file can be utilized at the migration destination apparatus same as the first configuration. Further, since the data in the first document file that is required to be converted can be converted using the information processing apparatus suitable for the conversion, the time required for conversion of the document file can be shortened, and the time required for transferring the converted document file can be shortened.

### Seventh Configuration:

As to the seventh configuration, the first document file 10A processable by another information processing apparatus (image forming apparatus 100A, migration source apparatus 300A) is migrated from another information processing apparatus to the information processing apparatus (image forming apparatus 100B, migration destination apparatus 300B) used as the local information processing apparatus that can process the second document file 10B. Each document file includes the main data 13 and the apparatus setting information 12 retaining data described in accordance of a given data structure used for processing the main data 13. As to the local information processing apparatus (image forming apparatus 100B, migration destination apparatus 300B), the communication unit (communication unit 125) receives the first document file from another information processing apparatus (image forming apparatus 100A, migration source apparatus 300A), the determination unit (configuration determination unit 122) determines the difference between the first data structure of the setting information processable by another information processing apparatus and the second data structure of the setting information proces sable by the local information processing apparatus, and the conversion unit (data conversion unit 123) converts the data structure of the setting information included in the first document file into the second data structure based on the determination result of the determination unit, to generate the second document file. In the seventh configuration, the local information processing apparatus used as the migration destination apparatus (image forming apparatus 100B) receives the first document file from another information processing apparatus used as the migration source apparatus (image forming apparatus 100A), and then converts all of data in the first document file required to be converted to generate the second document file. In seventh configuration, the document file can be utilized by the migration destination apparatus same as the fifth configuration.

### Eighth Configuration:

As to the eighth configuration, the first document file 10A proces sable by another information processing apparatus (image forming apparatus 100A, migration source apparatus 300A) is migrated from another information processing apparatus to the information processing apparatus (image forming apparatus 100B, migration destination apparatus 300B) used as the local information processing apparatus that can process the second document file 10B. Each document file includes the main data 13 and the apparatus setting information 12 retaining data described in accordance of a given data structure used for processing the main data 13. In the local information processing apparatus (image forming apparatus 100B, migration destination apparatus 300B), the determination unit (configuration determination unit 122) performs first determination processing to determine whether the first data structure of the setting information processable by another information processing apparatus and the second data structure of the setting information proces sable by the local information processing apparatus are different, and performs second determination processing to determine whether the first data format applied to the main data included in the first document file matches the second data format processable by the local information processing apparatus, and the communication unit (communication unit 125) receives, from another information processing apparatus, the third document file to which a process of converting the first data structure of the setting information in the first document file into the second data structure is already executed at another information processing apparatus or a process of converting the first data format applied to the main data in the first document file into the second data format is already executed at another information processing apparatus, and the conversion unit (data conversion unit 123) converts the first data format applied to the main data included in the third document file, to which the process of converting the first data structure of the setting information in the first document file into the second data structure is already executed, into the second data format when determining that the first data format and the second data format are different by performing the second determination processing, to generate the second document file, or the conversion unit (data conversion unit 123) converts the first data structure of the setting information included in the third document file, to which the process of converting the first data format applied to the main data in the first document file into the second data format is already executed at another information processing apparatus, into the second data structure of the setting information when determining that the first data structure and the second data structure are different by performing the first determination processing, to generate the second document file. In the eighth configuration, the local information processing apparatus used as the migration destination apparatus receives the third document file from another information processing apparatus used as the migration source apparatus, in which the third document file of the intermediate document file is generated by converting a part of data (i.e., any one of the setting information and the main data) that is required to be converted at another information processing apparatus, and then the remaining data in the third document file (i.e., remaining any one of the setting information and the main data) is converted at the local information processing apparatus used as the migration destination apparatus to generate the second document file. In the eighth configuration, the document file can be utilized by the migration destination apparatus same as the sixth configuration.

Typically, the document file includes the main data, which is print target data to be printed, and the setting information retaining data used for processing the main data. Since the data required for processing the main data is described with a data structure in accordance with a processing procedure of a processing program executed by the image forming apparatus, the data structure may differ for each type of the image forming apparatus, and types and ranges of parameters included in the setting information may differ for each type of the image forming apparatus, and thereby the setting information used in one image forming apparatus may not be used in another image forming apparatus. In conventional cases, the data format applied to facsimile data, corresponding to the main data, is converted, but the setting information is not processed as a conversion target in conventional image forming apparatuses. Therefore, even if the data format applied to the main data of the document file is converted in another data format processable by another image forming apparatus used as the data migration apparatus, another image forming apparatus used as the data migration apparatus cannot use the migrated document file because the image forming apparatus used as the data migration apparatus cannot interpret the setting information.

As to the above described embodiments, the data structure and/or the data format of the data included in the document file can be appropriately converted, so that the document file can be utilized at the migration destination apparatus.

Numerous additional modifications and variations are possible in light of the above teachings. It is therefore to be understood that, within the scope of the appended claims, the disclosure of this patent specification may be practiced otherwise than as specifically described herein.

Each of the functions of the above described embodiments can be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), system on a chip (SOC), graphics processing unit (GPU), and conventional circuit components arranged to perform the recited functions.

As described above, the present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

What is claimed is:

1. An information processing system to convert a first document file processable by a first information processing apparatus into a second document file processable by a second information processing apparatus, each of the first document file and the second document file including main data, and setting information retaining data described in accordance with a given data structure used for processing the main data, the information processing system comprising:
circuitry configured to
determine whether a first data structure of the setting information processable by the first information processing apparatus and a second data structure of the setting information processable by the second information processing apparatus are different; and
convert the first data structure of the setting information in the first document file into the second data structure of the setting information proces sable by the second information processing apparatus to generate the second document file when determining that the first data structure and the second data structure are different.

2. The information processing system according to claim 1,
wherein the circuitry determines the difference between the first data structure and the second data structure based on a difference between information related to an apparatus configuration of the first information processing apparatus and information related to an apparatus configuration of the second information processing apparatus.

3. The information processing system according to claim 1,
wherein the circuitry determines whether a first data format applied to the main data included in the first document file is processable by the second information processing apparatus,
wherein when the circuitry determines that the first data format is not processable by the second information processing apparatus, the circuitry converts the first data format applied to the main data included in the first document file into a second data format processable by the second information processing apparatus to generate the second document file.

4. The information processing system according to claim 1,
wherein each of the first document file and the second document file includes property information indicating property of the main data,
wherein the circuitry determines whether the first document file can be migrated from the first information processing apparatus to the second information processing apparatus based on the property information indicating the property of the main data.

5. An information processing apparatus to convert a first document file processable by the information processing apparatus into a second document file processable by another information processing apparatus, each of the first document file and the second document file including main data, and setting information retaining data described in accordance with a given data structure used for processing the main data, the information processing apparatus comprising;
circuitry configured to
perform first determination processing to determine whether a first data structure of the setting information processable by the information processing apparatus and a second data structure of the setting information processable by the another information processing apparatus are different; and
convert the first data structure of the setting information in the first document file into the second data structure of the setting information proces sable by the another information processing apparatus to generate the second document file when determining that the first data structure and the second data structure are different by performing the first determination processing.

6. The information processing apparatus according to claim 5,
wherein the circuitry further configured to
perform second determination processing to determine whether a first data format applied to the main data in the first document file matches a second data format processable by the another information processing apparatus; and
convert at least a part of the first document file proces sable by the information processing apparatus in accordance with the second document file processable by the another information processing apparatus to generate a third document file;
wherein the circuitry
converts at least the first data structure of the setting information in the first document file into the second data structure of the setting information processable by the another information processing apparatus when determining that the first data structure and the second data structure are different by performing the first determination processing, to generate the third document file, or
converts at least the first data format applied to the main data in the first document file into the second data format processable by the another information processing apparatus when determining that first data format does not match the second data format by performing the second determination processing, to generate the third document file.

7. An information processing apparatus to receive a first document file processable by another information processing apparatus, the information processing apparatus capable of processing second document file, each of the first document file and the second document file including main data, and setting information retaining data described in accordance with a given data structure used for processing the main data, the information processing comprising;
circuitry configured to
receive the first document file from the another information processing apparatus;
perform first determination processing to determine whether a first data structure of the setting information processable by the another information processing apparatus and a second data structure of the setting information proces sable by the information processing apparatus are different; and
convert the first data structure of the setting information in the first document file into the second data structure of the setting information proces sable by the information processing apparatus when determining that the first data structure and the second data structure are different by performing the first determination processing.

8. The information processing apparatus according to claim 7,
wherein the circuitry further configured to
perform second determination processing to determine whether a first data format applied to the main data in the first document file matches a second data format processable by the information processing apparatus; and
receive, from the another information processing apparatus, a third document file to which a process of converting the first data structure of the setting information in the first document file into the second data structure is already executed at the another information processing apparatus, or a process of converting the first data format applied to the main data in the first document file into the second data format is already executed at the another information processing apparatus, instead of receiving the first document file from the another information processing apparatus;
wherein the circuitry
converts the first data format applied to the main data included in the third document file, to which the process of converting the first data structure of the setting information in the first document file into the second data structure is already executed at the another information processing apparatus, into the second data format when determining that the first data format does not match the second data format by performing the second determination processing, to generate the second document file, or
converts the first data structure of the setting information included in the third document file, to which the process of converting the first data format applied to the main data in the first document file into the second data format is already executed at the another information processing apparatus, into the second data structure of the setting information when determining that the first data structure and the second data structure are different by performing the first determination processing, to generate the second document file.
